(19) United States
(12) Patent Application Publication
(10) Pub. No.: US 2007/0279618 A1
(43) Pub. Date: Dec. 6, 2007

(54) Imaging Apparatus And Image Improving Method

(75) Inventors: Misa Sano, Kanagawa (JP); Masato Nishizawa, Kanagawa (JP); Takuya Imaoka, Kanagawa (JP); Tsutomu Fujita, Chiba (JP); Masatomo Kanegae, Tokyo (JP)

Correspondence Address: PEARNE & GORDON LLP, 1801 EAST 9TH STREET, SUITE 1200, CLEVELAND, OH, 44114-3108, US

(73) Assignees: MATSUSHITA ELECTRIC INDUSTRIAL CO., LTD., Osaka (JP); RIVERBELL CO., LTD., Tokyo (JP)

(21) Appl. No.: 11/576,989

(22) PCT Filed: Oct. 14, 2005
(86) PCT No.: PCT/JP05/19348

§ 371 Date: Apr. 10, 2007

(30) Foreign Application Priority Data
Oct. 15, 2004 (JP) 2004-301198

(51) Int. Cl. G01N 21/00

(52) U.S. Cl. 356/72

(57) ABSTRACT

The present invention provides an imaging apparatus, comprising a multifocal lens (210) having a plurality of lens portions different from one another in focal length; an imaging device (29) for converting an image formed thereon by said multifocal lens (210) into an electric signal to be outputted therethrough as an image signal; a computing unit (33) for carrying out a weighted computing process on said image signal from said imaging device (29) in accordance with a predetermined compensation function to output a compensated image signal as an output image signal, and in which said compensation function is an inverse function obtained based on a point spread function with respect to an object disposed at a predetermined distance from an optical system constituted by said multifocal lens (210).

### TECHNICAL FIELD OF THE INVENTION

The present invention relates to an imaging apparatus such as, for example, an electronic camera, for taking an image of an object to have the image converted into an electronic image and a method of improving the electronic image, and more particularly to an imaging apparatus capable of taking an image of an object such as, for example, a bar code disposed in the vicinity thereof to have the image converted into an electronic image and a method of improving the electronic image.

### DESCRIPTION OF THE RELATED ART

As one example of an electronic apparatus having a function of inputting image information therethrough, there has been known a bar code reading apparatus for reading an image of an object disposed in the vicinity thereof. It is herein assumed that the object is, for example, a bar code attached to a surface of every commercial item. Firstly, the above mentioned conventional bar code reading apparatus is operative to form, on an imaging device such as, for example, a charge coupled device (hereinlater simply referred to as CCD), an image of the object, viz., the bar code collectively constituted by a plurality of bars and a plurality of spaces each intervening between the neighboring two bars to have the image converted into an electric signal. Secondly, the conventional bar code reading apparatus is operative to read the bar code after decoding electric signal into, for example, character information. There is proposed another bar code reading apparatus to read the bar code with high precision even in the case that the bar code is disposed from the bar code reading apparatus at a far distance, so as to enhance the operability of the conventional bar code reading apparatus. One typical example of the above mentioned conventional bar code reading apparatus is disclosed in, for example, Japanese Patent Laid-Open Publication No. H05-217012.

The conventional bar code reading apparatus disclosed therein is shown in FIG. 14A as comprising a nose portion 98 for collecting a light reflected from an object such as, for example, a bar code, a focusing optical system constituted by a multifocal lens 91 for focusing the light collected by the nose portion 98, an imaging device 99 for capturing an image formed thereon by the light focused by the multifocal lens 91 to have the image converted into a raw image signal, and a high pass filter 97 for filtering out a direct current (hereinlater simply referred to as “DC”) component from the raw image signal. Further, the multifocal lens 91 has an optical axis 10 and is constituted by a far lens portion 92 and a near lens portion 93 different from each other in focal length. The far lens portion 92 is longer in focal length than the near lens portion 93 but share the same optical axis 10 with each other.

FIG. 14B is a front view of the multifocal lens 91 viewed from a direction extending along the optical axis 10 of the multifocal lens 91. The far lens portion 92 is in the form of a circular shape and the near lens portion 93 is in the form of an annular shape and extending radially outwardly of a peripheral edge of the far lens portion 92 as clearly seen from FIG. 14B. The far lens portion 92 has a focal point 11 on the optical axis 10 and the near lens portion 93 has a focal point 13 on the optical axis 10. Further, the conventional bar code reading apparatus has a depth of field (hereinlater simply referred to as “DOF”) indicative of a maximum readable range determined by focal points of the multifocal lens 91. This means that the far lens portion 92 has a DOF 1 determined by the focal point 11 and the near lens portion 93 has a DOF 2 determined by the focal point 13 as clearly seen from FIG. 14B.

The imaging device 99 is operative to scan the image formed on the imaging device 99 to have the image converted into an electric signal to be outputted as a raw image signal to the high pass filter 97. The high pass filter 97 is operative to filter out a DC component from the raw image signal to output the filtered image signal as an image signal. The image signal will be later decoded by a signal processing unit, not shown in FIG. 14, into, for example, character information. Thus, the conventional bar code reading apparatus can read the bar code.

The multifocal lens 91 forming part of the conventional bar code reading apparatus is constituted by a far lens portion 92 having a long focal length 11 and a near lens portion 93 having a short focal length 12 shorter than the long focal length 11 as described hereinearlier. This leads to the fact that the conventional bar code reading apparatus thus constructed as previously mentioned encounters a drawback in that the image formed on the imaging device 99 is a composite of an image portion in sharp focus formed by the near lens portion 93 and an image portion out of focus formed by the far lens portion 92, and thus blurred in the case that the conventional bar code reading apparatus reads a bar code disposed in the close vicinity thereof, and conversely, the conventional bar code reading apparatus thus constructed as previously mentioned encounters another drawback in that the image formed on the imaging device 99 is a composite of an image portion in sharp focus formed by the far lens portion 92 and an image portion out of focus formed by the near lens portion 93, and thus blurred in the case that the conventional bar code reading apparatus reads a bar code disposed in the remote vicinity thereof, as will be described hereinlater with reference to FIG. 15.

FIG. 15 shows how images are formed on the imaging device 99 in the case that a point-like light source is disposed at the focal point 11 of the far lens portion 92 and in the case that the point-like light source is disposed at the focal point 13 of the near lens portion 93.

FIG. 15A shows a view explaining an image formed on the imaging device 99 in the case that the point-like light source is disposed at the focal point 11 of the far lens portion 92. FIG. 15B is a front view of a projected image 991a formed on the imaging device 99 viewed from a direction extending along the optical axis 10 of the multifocal lens 91. The image 991a formed on the imaging device 99 is a composite of an image portion a1 in sharp focus formed by the far lens portion 92 and an image portion a2 out of focus formed by the near lens portion 93 in the case that the point-like light source is disposed at the focal point 11 of the far lens portion 92. The image portion a2 out of focus and thus blurred is in the form of an annular shape having a predetermined width and extending radially outwardly of and spaced apart from the image portion a1 in sharp focus and in the form of a point-like shape at a radial distance d, as will be clearly seen from FIG. 15B.

Likewise, FIG. 15C shows a view explaining an image formed on the imaging device 99 in the case that the point-like light source is disposed at the focal point 13 of the near lens portion 93. FIG. 15D is a front view of a projected image 991b formed on the imaging device 99 viewed from a direction extending along the optical axis 10 of the multifocal lens 91. The image 991b formed on the imaging device 99 is a composite of an image portion b1 in sharp focus formed by the near lens portion 93 and an image portion b2 out of focus formed by the far lens portion 92 in the case that the point-like light source is disposed at the focal point 13 of the near lens portion 93. The image portion b2 out of focus and thus blurred is in the form of a circular shape and extending radially from the image portion b1 in sharp focus and in the form of a point-like shape with a radius r, as will be clearly seen from FIG. 15D.

As will be seen from the foregoing description, it will be understood that the image projected and formed on the imaging device 99 is blurred even through an object, viz., the bar code is disposed within the DOF of one of the far lens portion 92 and the near lens portion 93, resulting from the fact that the multifocal lens 91 is constituted by a far lens portion 92 and a near lens portion 93 different from each other in focal length and the image formed on the imaging device 99 is thus composite of an image portion in sharp focus formed by the one of the far lens portion 92 and the near lens portion 93 and an image portion out of focus formed by the remaining one of the far lens portion 92 and the near lens portion 93 although the image portion out of focus formed by the remaining one of the far lens portion 92 and the near lens portion 93 in part serves to bring the image portion in sharp focus into relief.

The imaging device 99 is operative to convert the out-of-focus image portion formed by the remaining one of the far lens portion 92 and the near lens portion 93, for example, the out-of-focus image portion a2 formed by the near lens portion 93 and in the form of an annular shape shown in FIG. 15B or the out-of-focus image portion b2 formed by the far lens portion 92 and in the form of a circular shape shown in FIG. 15D, into a DC component contained in the raw image signal.

The high pass filter 97 is operative to remove the DC component from the raw image signal so as to eliminate the out-of-focus image portion formed by the remaining one of the far lens portion 92 and the near lens portion 93 from the projected image. This means that the high pass filter 97 is operative to remove the DC component so as to eliminate the out-of-focus image portion formed by the near lens portion 93 in the case that the object, viz., the bar code is disposed within the DOF1. Conversely, the high pass filter 97 is operative to remove the DC component so as to eliminate the out-of-focus image portion formed by the far lens portion 92 in the case that the object, viz., the bar code is disposed within the DOF2. Thus, the conventional bar code reading apparatus is designed to improve the range of the DOF because of the fact that the conventional bar code reading apparatus comprises a high pass filter 97 for removing the DC component so as to eliminate the out-of-focus image portion. This means that the conventional bar code reading apparatus can improve the DOF, resulting from the fact that the far-distance DOF1 is obtained in addition to the near-distance DOF2 as clearly seen from FIG. 14A, thereby making it possible for the conventional bar code reading apparatus to read the bar code with high prevision even in the case that the bar code is disposed from the conventional bar code reading apparatus at a far distance.

The conventional bar code reading apparatus thus constructed as previously mentioned, however, encounters a drawback in that the conventional bar code reading apparatus cannot read a high quality image of a sophisticated object in comparison with, for example, a regular camera unit designed to take an image of a person or a landscape although the conventional bar coder reading apparatus is effective in reading an image of a graphical object such, as for example, a bar code. More specifically, an image signal taken and converted by the regular camera unit from an image of an object includes low frequency components including DC components indicative of a gradual change of brightness and color of the image of the object. This means that the conventional bar code reading apparatus is required to compensate the out-of-focus image portion in the case that an image of a sophisticated object such as, for example, a person or a landscape is taken using a multifocal lens because of the fact that the quality of the image is deteriorated if the conventional bar code reading apparatus simply removes the DC component indicative of the out-of-focus image portion.

Particularly, as represented by a mobile cellular phone, an information terminal apparatus provided with an image inputting function is becoming popular in recent years. Providing a camera function of taking an in-sharp-focus image of a person or a landscape as well as the aforementioned reading function of reading a close-up object such as, for example, a bar code will result in further enhancement of convenience for such an information terminal apparatus. The bar code may indicate various information such as, for example, a mail address, a home page address, a telephone number, and the like, thereby making it possible for the information terminal apparatus to realize extremely useful communication when the bar code is utilized in combination with the desired image. It is strongly desired that there would be emerged an information terminal apparatus capable of taking an image of a close-up object as well as an image of an object disposed at a far distance therefrom with high precision.

As a method of compensating the out-of-focus image portion with high precision to obtain a clear and sharp image, there is known an image processing process using an inverse filter for compensating the out-of-focus image portion. The inverse filter is constituted by, for example, a digital filter, and designed to carry out a filtering process on the out-of-focus image portion to compensate an optical transfer characteristic of, for example, a lens. The transfer characteristic in the optical system is represented by a point spread function (hereinlater simply referred to as “PSF”). The PSF can be obtained by way of experiments or computations. In the case of, for example, the conventional bar code reading apparatus shown in FIG. 15, the image projected and formed on the imaging device 99 with respect to the point-like light source can be represented by the PSF. This means that the projected image 991a shown in FIG. 15B and the projected image 991b shown in FIG. 15D can be represented by the PSF of the multifocal lens 91. This leads to the fact that a transfer characteristic H representative of out-of-focus image portions, for example, the out-of-focus image portion a2 forming part of the projected image 991a shown in FIG. 15B and the out-of-focus image portion b2 forming part of the projected image 991b shown in FIG. 15D can be obtained by way of experiments or computations. The fact that the transfer characteristic H representative of the out-of-focus image portions can be obtained leads to the fact that the out-of-focus image portions can be compensated with high precision when an inverse transfer characteristic 1/H is computed in inverse relation to the transfer characteristic H, and a filtering process is carried out on the raw image signal outputted from the imaging device 99 using an inverse filter having the inverse transfer characteristic 1/H in inverse relation to the transfer characteristic H thus calculated.

Another drawback, however, is encountered in that the PSF changes in accordance with the position of the point-like light source as clearly seen from FIG. 15 and the inverse transfer characteristic 1/H with respect to every possible position of the object is thus required to be calculated and prepared in advance, thereby tremendously increasing an amount of operations. Further, a focusing function such as, for example, an auto focusing function is required to obtain the inverse transfer characteristic 1/H with respect to every possible position of the object, thereby further increasing the amount of operations.

This means that the PSF with respect to the object disposed in the remote vicinity substantially represents the projected image 991a in shape as shown in FIG. 15B and the PSF with respect to the object disposed in the close vicinity substantially represents the projected image 991b in shape as shown in FIG. 15D in the case of the multifocal lens 91 forming part of the conventional bar code reading apparatus. Further, the projected images change in size in accordance with the position of the object. As will be seen from the foregoing description, it will be understood that the conventional bar code reading apparatus is required to calculate and prepare in advance the inverse transfer characteristic 1/H with respect to every possible position of the object in order to compensate the out-of-focus image portions with high precision to produce a sharp image in the case of the multifocal lens 91 forming part of the conventional bar code reading apparatus.

The present invention is made for the purpose of overcoming the above mentioned drawbacks, and it is therefore an object of the present invention to provide an imaging apparatus for and image improving method capable of taking a sharp image of an object with ease and high precision regardless of whether the object is disposed therefrom at a reference distance or at a distance shorter than the reference distance.

### DISCLOSURE OF THE INVENTION

In accordance with a first aspect of the present invention, there is provided an imaging apparatus, comprising: a multifocal lens having a plurality of lens portions different from one another in focal length; an imaging device for converting an image formed thereon by the multifocal lens into an electric signal to be outputted therethrough as an image signal; a computing unit for carrying out a weighted computing process on the image signal from the imaging device in accordance with a predetermined compensation function to output a compensated image signal as an output image signal, and in which the compensation function is an inverse function obtained based on a point spread function with respect to an object disposed at a predetermined distance from an optical system constituted by the multifocal lens.

The imaging apparatus according to the present invention thus constructed as previously mentioned can take a sharp image of an object with ease and high precision regardless of whether the object is disposed at a reference distance or at a distance shorter than the reference distance.

In the imaging apparatus according to the present invention, the multifocal lens may have a representative lens portion, and the point spread function with respect to the object disposed at the predetermined distance from the optical system may be a point spread function of the multifocal lens with respect to the object disposed at a focal point of the representative lens portion. The point spread function of the multifocal lens may be a point spread function with respect to the object disposed at the focal point of the representative lens portion on an optical axis of the multifocal lens. Further, the point spread function of the multifocal lens may be a point spread function with respect to the object disposed at the focal point of the representative lens portion on a focal plane spaced apart from an optical axis of the multifocal lens at a predetermined distance.

The imaging apparatus according to the present invention thus constructed as previously mentioned can obtain the point spread function with ease and high precision, thereby enabling to take a sharp image of an object with ease and high precision regardless of whether the object is disposed at a reference distance or at a distance shorter than the reference distance.

In the imaging apparatus according to the present invention, the point spread function with respect to the object disposed at the predetermined distance from the optical system may be a point spread function obtained based on the result of multiplying a point spread function of each of the lens portions forming part of the multifocal lens with respect to its focal point by a predetermined ratio, and adding up the point spread functions of all of the lens portions thus multiplied by the predetermined ratios. Further, the point spread function with respect to the object disposed at the predetermined distance from the optical system may be a point spread function obtained based on the result of multiplying a point spread function of each of the lens portions forming part of the multifocal lens with respect to its focal point on an optical axis of the multifocal lens by a predetermined ratio, and adding up the point spread functions of all of the lens portions thus multiplied by the predetermined ratios. Furthermore, the point spread function with respect to the object disposed at the predetermined distance from the optical system may be a point spread function obtained based on the result of multiplying a point spread function of each of the lens portions forming part of the multifocal lens with respect to its focal point on a focal plane spaced apart at a predetermined distance from an optical axis of the multifocal lens by a predetermined ratio, and adding up the point spread functions of all of the lens portions thus multiplied by the predetermined ratios.

The imaging apparatus according to the present invention thus constructed as previously mentioned can calculate the point spread function with ease and high precision, thereby enabling to take a sharp image of an object with ease and high precision regardless of whether the object is disposed at a reference distance or at a distance shorter than the reference distance.

In the imaging apparatus according to the present invention, the multifocal lens may be constituted by a first lens portion having a first focal length and a second lens portion having a second focal length different from the first focal length, the first lens portion and the second lens portion may be integrally formed with each other and collectively form a plane of the multifocal lens in the form of a shape selected from among a circular shape, an elliptical shape, and a polygonal shape viewed from a direction extending along an optical axis of the multifocal lens, and the first lens portion and the second lens portion may be neighboring to each other along a straight line extending through a center of the multifocal lens.

Further, in the imaging apparatus according to the present invention, the multifocal lens may be constituted by a first lens portion having a first focal length and a second lens portion having a second focal length different from the first focal length, the first lens portion and the second lens portion may be integrally formed with each other, and the first lens portion and the second lens portion may be alternately neighboring to each other in concentric relationship with one of the first lens portion and the second lens portion in the form of a shape selected from among a circular shape, an elliptical shape, and a polygonal shape to collectively form a plane of the multifocal lens viewed from a direction extending along an optical axis of the multifocal lens. In the aforementioned imaging apparatus, the total area of the first lens portion may be substantially equal to the total area of the second lens portion viewed from a direction extending along an optical axis of the multifocal lens.

The imaging apparatus according to the present invention thus constructed as previously mentioned can focus the image on the imaging device with ease and high precision.

Furthermore, in the imaging apparatus according to the present invention, the multifocal lens may be constituted by a group of the number N of lens portions including a first lens portion to a N-th lens portion respectively having focal lengths different from one another, N being an integer equal to or greater than two, the number N of the lens portions including the first lens portion to the N-th lens portion may be integrally formed with one another, and the number N of the lens portions including the first lens portion to the N-th lens portion may be disposed respectively in alternately neighboring relationship with one another in concentric relationship with the first lens portion in the form of a shape selected from among a circular shape, an elliptical shape, and a polygonal shape to collectively form a plane of the multifocal lens viewed from a direction extending along an optical axis of the multifocal lens. In the aforementioned imaging apparatus, the multifocal lens portion may be further constituted by the number M of groups including a first group to M-th group of lens portions each group having the number N of lens portions including a i-th first lens portion to an i-th N-th lens portion respectively equal in focal length to the first lens portion to the N-th lens portion, M being an integer equal to or greater than one, and i is an integer equal to or less than M, the i-th first lens portion to the i-th N-th lens portion may be disposed respectively in alternately neighboring relationship with one another in concentric relationship with the first lens portion and radially extending outwardly of (i-1)-th N-th lens portion, and the number M×N of the lens portions including the first lens portion to the M-th N-th lens portion may be integrally formed with one another and collectively form a plane of the multifocal lens viewed from a direction extending along an optical axis of said multifocal lens. The multifocal lens may have one ore more adjoining places where neighboring lens portions are fixedly connected with each other, and a light shielding process is made on each of the adjoining places in order to reduce stray light generated therefrom. In the aforementioned imaging apparatus, the number N of lens portions may be substantially equal in a total area to one another viewed from a direction extending along an optical axis of the multifocal lens.

The imaging apparatus according to the present invention thus constructed as previously mentioned can focus the image on the imaging device with ease and high precision, thereby enabling to take a sharp image of an object with ease and high precision regardless of whether the object is disposed at a reference distance or at a distance shorter than the reference distance.

In the imaging apparatus according to the present invention, the computing unit may include a digital filter section having stored therein arrays of coefficients obtained in accordance with the predetermined compensation function, the digital filter section may be operative to input, as the image signal, digitalized image data converted from the image signal outputted from the imaging device and carrying out a computing process on the image signal based on the result of multiplying the image data by the coefficients. In the aforementioned imaging apparatus, the image signal outputted from the imaging device may be made up of a plurality of data components to be aligned in the form of a matrix in vertical and horizontal directions, the digital filter section may be constituted by a two-dimensional digital filter having stored therein a plurality of coefficients calculated in accordance with the predetermined compensation function, the coefficients may be to be aligned in the form of the matrix in vertical and horizontal directions and respectively corresponding to the data components in positions of the matrix, and the digital filter may be operative to carry out the weighted computing process on the image signal based on the result of multiplying each of the data components by one of the coefficients corresponding to each of the data components in the position of the matrix, and adding up all of the data components thus multiplied by the coefficients. The imaging device may be constituted by solid-state image sensing devices respectively corresponding to image elements and aligned in the form of the matrix in vertical and horizontal directions, and respectively corresponding to the data components in positions of the matrix. The image signal outputted from the imaging device may include red, green and blue data components respectively indicative of three primary colors, and the digital filter section may be operative to carry out a weighted computing process on each of the red, green and blue data components.

The imaging apparatus according to the present invention thus constructed as previously mentioned can carry out a weighted computing process with ease and high precision.

Further, in the aforementioned imaging apparatus, the solid-state image sensing devices may respectively correspond to a plurality of image elements each indicative of a primary color and are aligned checker-wise to output, as an image signal, a plurality of data components each indicative of the primary color in the order that the solid-state image sensing devices are aligned. The computing unit may be operative to input the data components respectively outputted from the solid-state image sensing devices, and the digital filter section may be operative to carry out the weighted computing process on each of the data components with the plurality of coefficients.

The imaging apparatus according to the present invention thus constructed as previously mentioned can carry out a weighted computing process with ease and high precision.

In the aforementioned imaging apparatus, the coefficients may include an effective coefficient corresponding to an image element in the matrix, the effective coefficient may be calculated based on the result of multiplying a coefficient corresponding to the image element in the matrix and a plurality of neighboring coefficients placed in the vicinity of the coefficient in the matrix by respective predetermined weighted values, and adding up the coefficient and the neighboring coefficients respectively thus multiplied. Alternately, the solid-state image sensing devices may be aligned in the order of Bayer array to output R, Gr, B, and GB data components respectively indicative of primary colors in the order of Bayer array.

The imaging apparatus according to the present invention thus constructed as previously mentioned can carry out a weighted computing process with ease and high precision, thereby enabling to take a sharp image of an object with ease and high precision regardless of whether the object is disposed at a reference distance or at a distance shorter than the reference distance.

In accordance with a second aspect of the present invention, there is provided an image improving method, comprising a preparing step of preparing a multifocal lens having a plurality of lens portions different from one another in focal length; an imaging device for converting an image formed thereon by the multifocal lens into an electric signal to be outputted therethrough as an image signal; an inputting step of inputting the image signal, a converting step of converting the image signal into digitalized image data, a computing step of carrying out a weighted computing process on the image data in accordance with a compensation function to obtain compensated image data, the compensation function being an inverse function of a point spread function with respect to an object disposed at a predetermined distance from an optical system constituted by the multifocal lens, and an outputting step of outputting the compensated image data as output image data.

The image improving method according to the present invention thus constructed as previously mentioned can take a sharp image of an object with ease and high precision regardless of whether the object is disposed at a reference distance or at a distance shorter than the reference distance.

In the image improving method according to the present invention the multifocal lens may have a representative lens portion, and the point spread function with respect to the object disposed at the predetermined distance from the optical system may be a point spread function of the multifocal lens with respect to the object disposed at a focal point of the representative lens portion. Further, the point spread function of the multifocal lens may be a point spread function with respect to the object disposed at the focal point of the representative lens portion on an optical axis of the multifocal lens. Furthermore, the point spread function of the multifocal lens may be a point spread function with respect to the object disposed at the focal point of the representative lens portion on a focal plane spaced apart from an optical axis of the multifocal lens at a predetermined distance.

The image improving method according to the present invention thus constructed as previously mentioned can obtain the point spread function with ease and high precision.

In the image improving method according to the present invention, the point spread function with respect to the object disposed at the predetermined distance from the optical system may be a point spread function obtained based on the result of multiplying a point spread function of each of the lens portions forming part of the multifocal lens with respect to its focal point by a predetermined ratio, and adding up the point spread functions of all of the lens portions thus multiplied by the predetermined ratios. Further, the point spread function with respect to the object disposed at the predetermined distance from the optical system may be a point spread function obtained based on the result of multiplying a point spread function of each of the lens portions forming part of the multifocal lens with respect to its focal point on an optical axis of the multifocal lens by a predetermined ratio, and adding up the point spread functions of all of the lens portions thus multiplied by the predetermined ratios. Furthermore, the point spread function with respect to the object disposed at the predetermined distance from the optical system may be a point spread function obtained based on the result of multiplying a point spread function of each of the lens portions forming part of the multifocal lens with respect to its focal point on a focal plane spaced apart at a predetermined distance from an optical axis of the multifocal lens by a predetermined ratio, and adding up the point spread functions of all of the lens portions thus multiplied by the predetermined ratios.

The image improving method according to the present invention thus constructed as previously mentioned can obtain the point spread function with ease and high precision, thereby enabling to take a sharp image of an object with ease and high precision regardless of whether the object is disposed at a reference distance or at a distance shorter than the reference distance.

In the image improving method, the computing step may have a step of carrying out a convolution computation of the image data to an array of coefficients obtained in accordance with the predetermined compensation function. The image data may be made up of a plurality of data components to be aligned in the form of a matrix in vertical and horizontal directions, the coefficients may be to be aligned in the form of the matrix in vertical and horizontal directions and respectively corresponding to the data components in positions of the matrix, the computing step may have a step of carrying out a convolution computation of the data components to the coefficients respectively correspondent in the positions of the matrix. The imaging device may be constituted by a plurality of solid-state image sensing devices respectively corresponding to a plurality of image elements each indicative of a primary color and may be aligned checker-wise in the form of the matrix in vertical and horizontal directions to output, as an image signal, a plurality of data components each indicative of the primary color in the order that the solid-state image sensing devices are aligned, and the computing step may have a step of carrying out a convolution computation of the data components to the coefficients respectively correspondent in the positions of the matrix. In the aforementioned image improving method, the coefficients may include an effective coefficient corresponding to an image element in the matrix, the effective coefficient may be calculated based on the result of multiplying a coefficient corresponding to the image element in the matrix and a plurality of neighboring coefficients placed in the vicinity of the coefficient in the matrix by respective predetermined weighted values, and adding up the coefficient and the neighboring coefficients respectively thus multiplied.

The imaging apparatus according to the present invention thus constructed as previously mentioned can calculate the point spread function with ease and high precision.

In the image improving method according to the present invention, the solid-state image sensing devices may be aligned in the order of Bayer array to output R, Gr, B, and GB data components respectively indicative of primary colors in the order of Bayer array, the computing step may have a step of carrying out a convolution computation of the R, Gr, B, and GB data components to the coefficients respectively correspondent in the positions of the matrix.

The imaging apparatus according to the present invention thus constructed as previously mentioned can carry out a weighted computing process with ease and high precision, thereby enabling to take a sharp image of an object with ease and high precision regardless of whether the object is disposed at a reference distance or at a distance shorter than the reference distance.

### BRIEF DESCRIPTION OF THE DRAWINGS

The features and advantages of an imaging apparatus and an image improving method according to the present invention will be more clearly understood from the following description taken in conjunction with the accompanying drawings in which:

FIG. 1 is a block diagram showing a first preferred embodiment of the imaging apparatus according to the present invention;

FIG. 2A is a side view of a multifocal lens forming part of the imaging apparatus shown in FIG. 1;

FIG. 2B is a front view of the multifocal lens shown in FIG. 2A;

FIG. 3A is a block diagram explaining how an image of an object is formed on an imaging device forming part of the imaging apparatus shown in FIG. 1 in the case that the object is disposed at a long distance;

FIG. 3B is a front view of the image formed on the imaging device shown in FIG. 3A;

FIG. 3C is a block diagram explaining how an image of the object is formed on the imaging device forming part of the imaging apparatus shown in FIG. 1 in the case that the object is disposed at a short distance;

FIG. 3D is a front view of the image formed on the imaging device shown in FIG. 3C;

FIG. 4 is a block diagram explaining a principle of an image processing operation performed by the imaging apparatus shown in FIG. 1;

FIG. 5 is a block diagram showing a construction of an image improving filter section forming part of the imaging apparatus shown in FIG. 1;

FIG. 6 is a block diagram showing a second preferred embodiment of the imaging apparatus according to the present invention;

FIG. 7A is a side view of an example of a multifocal lens forming part of the imaging apparatus shown in FIG. 6;

FIG. 7B is a front view of the multifocal lens shown in FIG. 7A;

FIG. 8A is a block diagram explaining how an image of an object is formed on an imaging device forming part of the imaging apparatus shown in FIG. 6 having the multifocal lens shown in FIG. 7 in the case that the object is disposed at a long distance;

FIG. 8B is a front view of the image formed on the imaging device shown in FIG. 8A;

FIG. 8C is a block diagram similar to FIG. 8A but in the case that the object is disposed at a short distance;

FIG. 8D is a front view of the image formed on the imaging device shown in FIG. 8C;

FIG. 9A is a side view of another example of a multifocal lens forming part of the imaging apparatus shown in FIG. 6;

FIG. 9B is a front view of the multifocal lens shown in FIG. 9A;

FIG. 10A is a block diagram explaining how an image of an object is formed on an imaging device forming part of the imaging apparatus shown in FIG. 6 having the multifocal lens shown in FIG. 9 in the case that the object is disposed at a long distance;

FIG. 10B is a front view of the image formed on the imaging device shown in FIG. 10A;

FIG. 10C is a block diagram similar to FIG. 10A but in the case that the object is disposed at a short distance;

FIG. 10D is a front view of the image formed on the imaging device shown in FIG. 10C;

FIG. 11 is a block diagram showing a construction of an image improving filter section forming part of a third preferred embodiment of the imaging apparatus according to the present invention;

FIG. 12 is a block diagram showing an example of a Bayer array of solid-state imaging devices forming part of the third preferred embodiment of the imaging apparatus according to the present invention;

FIG. 13 is a block diagram explaining how an image of an object is formed on an imaging device forming part of the imaging apparatus shown in FIG. 1 in the case that that the object is disposed on a focal plane apart from the optical axis of the multifocal lens at a predetermined distance;

FIG. 14A is a block diagram showing a conventional bar code reading apparatus;

FIG. 14B is a front view of the multifocal lens forming part of the conventional bar code reading apparatus shown in FIG. 14A;

FIG. 15A is a block diagram explaining how an image of an object is formed on an imaging device forming part of the conventional bar code reading apparatus shown in FIG. 14A in the case that the object is disposed at a long distance;

FIG. 15B is a front view of the image formed on the imaging device shown in FIG. 15A;

FIG. 15C is a block diagram similar to FIG. 15A but in the case that the object is disposed at a short distance; and

FIG. 15D is a front view of the image formed on the imaging device shown in FIG. 15C.

### DESCRIPTION OF THE PREFERRED EMBODIMENTS

A preferred embodiment of the present invention will be described hereinafter with reference to the drawings.

### First Preferred Embodiment

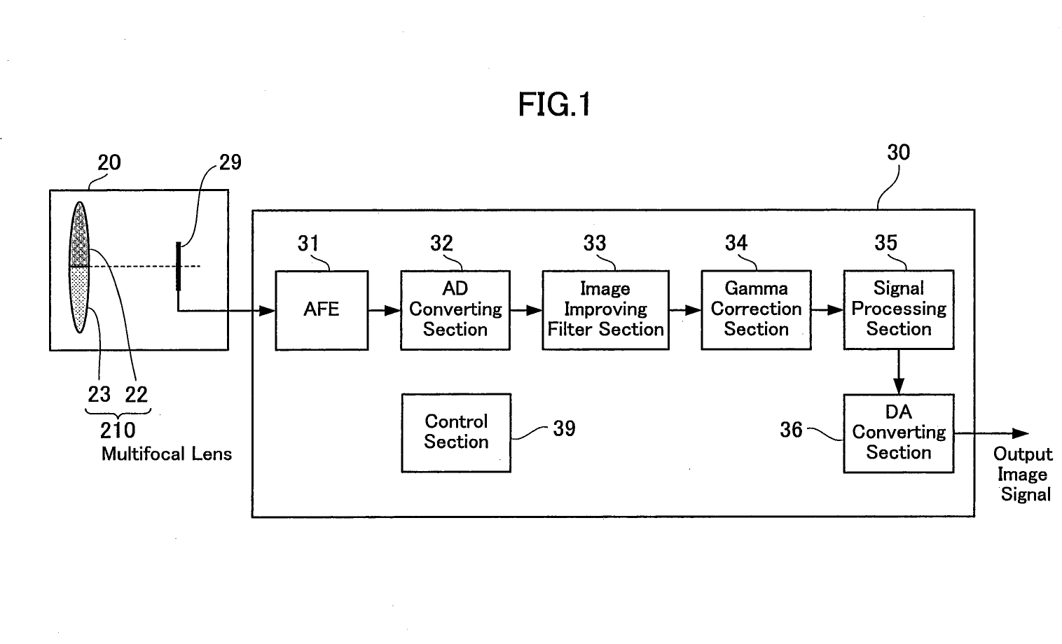

FIG. 1 is a block diagram showing a first preferred embodiment of an imaging apparatus according to the present invention.

As will be clearly seen from FIG. 1, the first embodiment of the imaging apparatus according to the present invention comprises an optical system constituted by an imaging unit 20 for taking an image of an object to have the image converted into an electric signal as a raw image signal, and an image processing unit 30 for carrying out an image processing operation on the raw image signal inputted from the imaging unit 20 to produce an image signal as an output image signal.

The imaging unit 20 includes a multifocal lens 210 for taking an image of the object, and an imaging device 29 for capturing the image taken by the multifocal lens 210 and thus formed thereon. The multifocal lens 210 is constituted by a plurality of lens portions different from one another in focal length. The imaging device 29 is designed to convert the image taken by the multifocal lens 210 and formed thereon into an electric signal to be outputted therethrough as a raw image signal.

The image processing unit 30 includes an analog front end, hereinlater simply referred to as “AFE” 31 for processing and amplifying the raw image signal inputted from the imaging unit 20, and an analog to digital converting section, hereinlater simply referred to “AD” converting section 32 for converting the raw image signal amplified by the AFE 31 from an analog format to a digital format to be outputted therethrough as digital image data.

The image processing unit 30 further includes a computing unit constituted by an image improving filter section 33 for carrying out an image improving operation on the digital image data inputted from the AD converting section 32. This means that the image processing unit 30 is operative to compensate an out-of-focus image portion of the image data caused by the multifocal lens 210 by way of the image improving operation according to the present invention. The image improving filter section 33 has stored therein arrays of coefficients obtained in accordance with a predetermined compensation function, and adding up arrays of image data elements forming part of the image data respectively multiplied by the arrays of the coefficients stored in the storage section. This means that the image improving filter section 33 can be constituted by a Finite Impulse Response Digital filter having the arrays of coefficients corresponding to the compensation function as its filter functions. Here, each of the filter functions of the image improving filter section 33 has been in advance computed based on an inverse function of the point spread function with respect to the object disposed at a predetermined distance in the optical system constituted by the multifocal lens 210. As will be seen from the foregoing description, the image improving filter section 33 thus constructed as previously mentioned can add up the arrays of image data elements forming part of the image data respectively multiplied by the arrays of the coefficients obtained in accordance with a predetermined compensation function to produce compensated image data to be outputted therethrough.

The compensated image data has been nonlinearly converted by the imaging device 29 from the optical image. The image processing unit 30 further includes a gamma correction section 34 for inputting the compensated image data from the image improving filter section 33 to carry out a gamma correction process, which is an inverse nonlinear correction process, on the compensated image data to output corrected image data.

The image processing unit 30 further includes a signal processing section 35, a digital to analog converting section, hereinlater simply referred to as “DA” converting section 36, and a control section 39.

The signal processing section 35 is operative to carry out a various kinds of signal processing operations on the corrected image data inputted from the gamma correction section 34 to output processed image data. The signal processing section 35 may be operative to, for example, store the corrected image data as an electronic photo, edit the stored image data and the like. Further, the signal processing section 35 is operative to decode character information from the image data in the case that the imaging device 29 has taken an image of, for example, a bar code, or the like. The signal processing operations carried out by the signal processing section 35 may be determined in accordance with user's instruction. The DA converting section 36 is operative to convert the processed image data inputted from the signal processing section 35 from a digital format to an analog format to output an analog image signal therethrough as an output image signal. The DA converting section 36 is operative to output the output image signal to, for example, a display unit for displaying a still image or a moving image based on the image signal outputted from the image processing unit 30. The control section 39 is constituted by, for example, a microcomputer and operative to control each of the constituent elements forming part of the image processing unit 30 in cooperation with the imaging unit 20 to produce an optimum image signal.

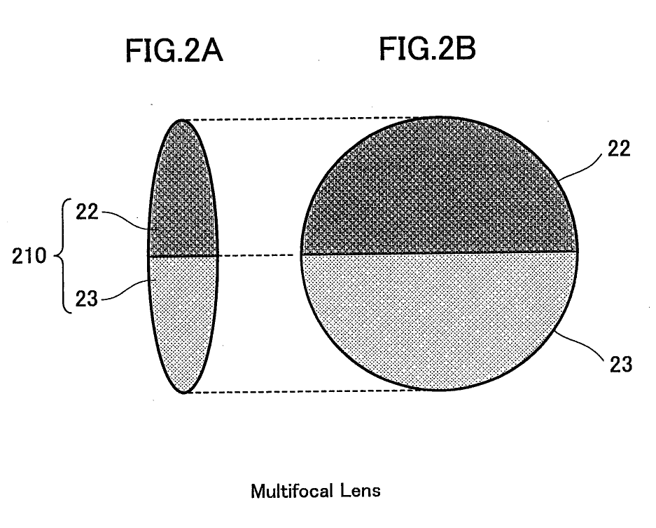

In the present embodiment, the multifocal lens 210 forming part of the imaging unit 20 is constituted by a bifocal lens. FIG. 2 is a block diagram showing the multifocal lens 210 in detail. FIG. 2A is a side view of the multifocal lens 210 viewed from a direction perpendicular to an optical axis 10 of the multifocal lens 210. FIG. 2B is a front view of the multifocal lens 210 viewed from a direction extending along the optical axis of the multifocal lens 210. As clearly seen from FIG. 2, the multifocal lens 210 is a bifocal optical system constituted by a far lens portion 22 having a long focal length and a near lens portion 23 having a short focal length shorter than that of the far lens portion 22. As clearly seen from FIG. 2B, each of the far lens portion 22 and the near lens portion 23 is in the form of a semi-circular shape. The far lens portion 22 and the near lens portion 23 are neighboring to each other along a line extending through the center of the multifocal lens 210 and respectively form an upper half portion and a lower half portion of the multifocal lens 210.

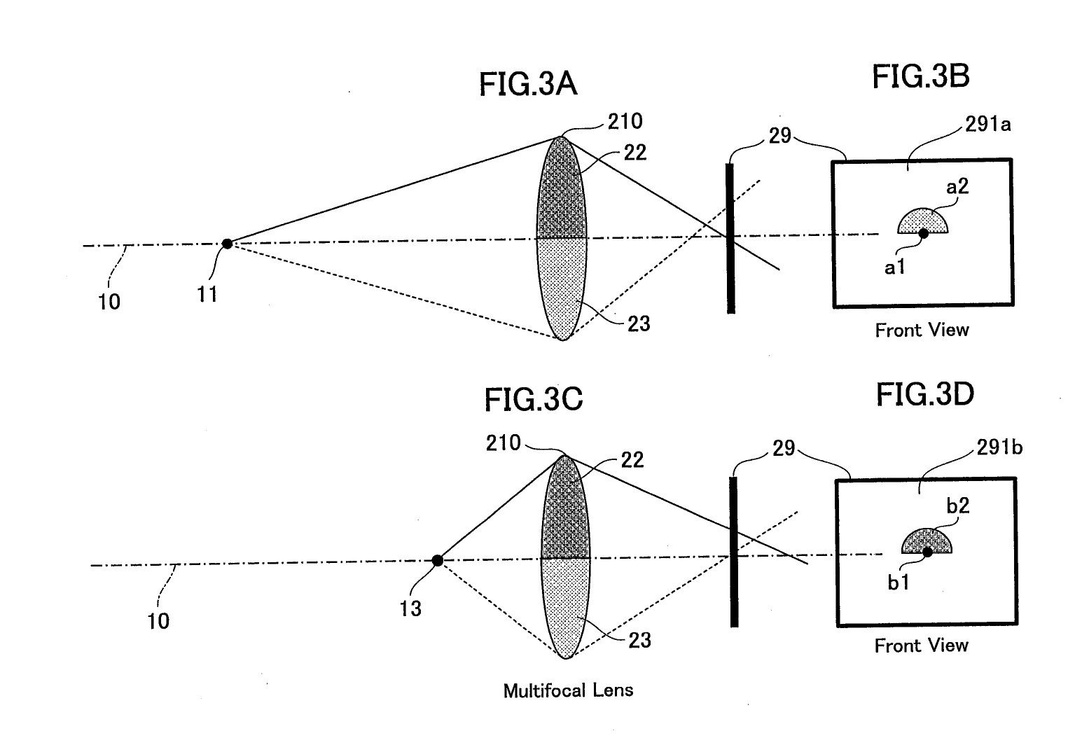

FIG. 3 shows how images are focused by the multifocal lens 210 and formed on the imaging device 29. FIG. 3A shows a view explaining how an image is formed on the imaging device 29 in the case that the point-like light source is disposed at the focal point 11 of the far lens portion 22. FIG. 3B is a front view of a projected image 291 a formed on the imaging device 29 viewed from a direction extending along the optical axis 10 of the multifocal lens 210. As will be clearly seen from FIG. 3B, the image 291a formed on the imaging device 29 is a composite of an image portion a1 in sharp focus formed by the far lens portion 22 and an image portion a2 out of focus formed by the near lens portion 23 wherein the in-focus image portion a1 is in the form of a point-like shape and the out-of-focus image portion a2 is in the form of a semi-circular shape and radially outwardly extending from the image portion a1 to form an upper half circular portion.

Likewise, FIG. 3C shows a view explaining how an image is formed on the imaging device 29 in the case that the point-like light source is disposed at the focal point 13 of the near lens portion 23. FIG. 3D is a front view of a projected image 291b formed on the imaging device 29 viewed from a direction extending along the optical axis 10 of the multifocal lens 210. As will be clearly seen from FIG. 3D, the image 291b formed on the imaging device 29 is a composite of an image portion b1 in sharp focus formed by the near lens portion 23 and an image portion b2 out of focus formed by the far lens portion 22 wherein the in-focus image portion b1 is in the form of a point-like shape and the out-of-focus image portion b2 is in the form of a semi-circular shape and radially outwardly extending from the image portion b1 to form an upper half circular portion. This means that the image 291b formed on the imaging device 29 is a composite of the in-focus image portion b1 in the form of a point-like shape and the out-of-focus image portion b2 radially extending outwardly of the in-focus image portion b1 to form an upper half circle in the case that the point-like light source is disposed at the focal point 13 of the near lens portion 23 similar to the image 291a formed on the imaging device 29 in the case that the point-like light source is disposed at the focal point 11 of the far lens portion 22.

From the foregoing description, it will be understood that the image formed on the imaging device 29 is substantially similar in shape regardless of whether the point-like light source is disposed at the focal point 11 of the far lens portion 22 or at the focal point 13 of the near lens portion 23 as long as the multifocal lens 210 forming part of the imaging unit 20 is constituted by the far lens portion 22 and the near lens portion 23, each in the form of a semi-circular shape, to collectively complete the multifocal lens 210 in the form of a circular shape viewed from a direction extending along the optical axis 10 of the multifocal lens 210. This results in the fact that the PSF representative of the image 291a formed on the imaging device 29 with respect to the focal point 11 of the far lens portion 22 is approximately the same as the PSF representative of the image 291b formed on the imaging device 29 with respect to the focal point 13 of the near lens portion 23 in the present embodiment of the imaging apparatus.

The operation of the present embodiment of the imaging apparatus thus constructed as previously mentioned will be described hereinlater.

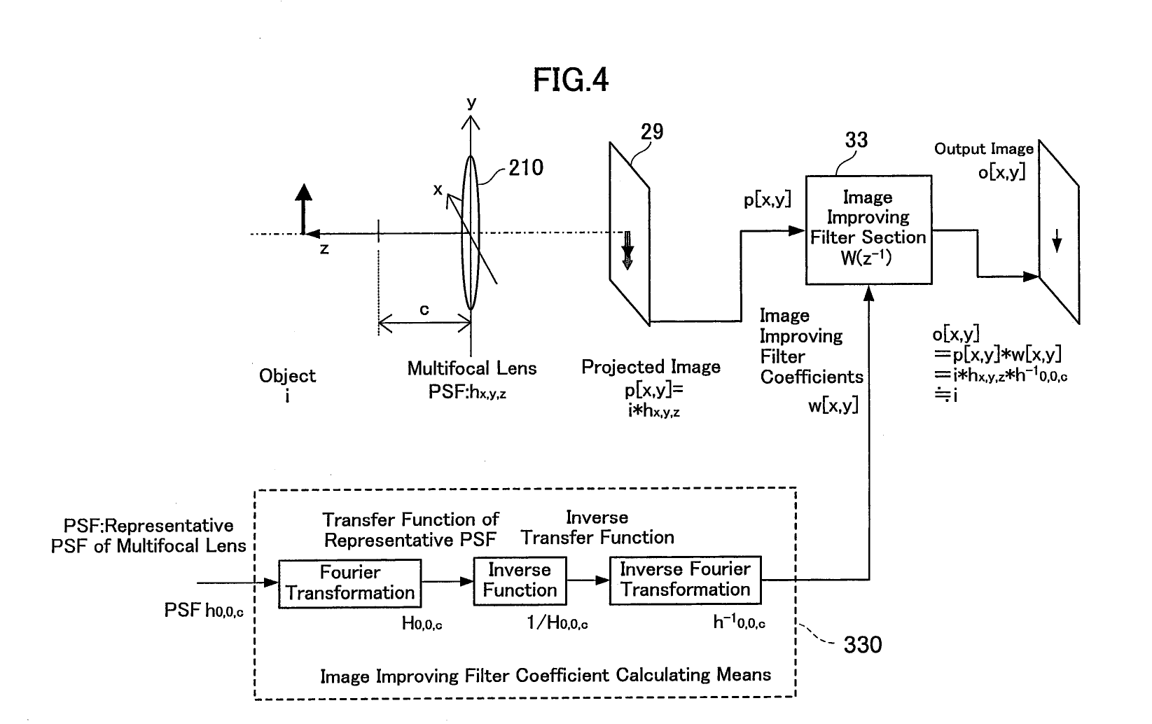

FIG. 4 is a block diagram explaining a principle of compensating the out-of-focus image portion of the image focused by the multifocal lens 210. The image focused by a lens (including a multifocal lens) and formed on an imaging device is, in general, determined in accordance with a PSF. The PSF is a space-variant function having variables of a vertical direction parameter x, a horizontal direction parameter y, and a parameter z indicative of a distance between the lens portion and the object. It is hereinlater assumed that the PSF of the multifocal lens 210 is represented by h (x, y, z), the object is represented by a parameter i, and the image projected and formed on the imaging device 29 is represented by p [x, y]. p [x, y] can be expressed as a convolution of the object parameter i to the PSF of the multifocal lens 210, viz., h (x, y, z) as follows.
p[x, y]=I*h(x, y, z)

Wherein * is intended to mean a convolution computation.

Further, transfer function H (x, y, z) representative of the transfer characteristic of the multifocal lens 210 can be calculated after PSF h (x, y, z) representative of the PSF of the multifocal lens 210 with space coordinates x, y, z is transformed by way of coordinate transformation such as, for example, Fourier transformation, z-transformation, or the like. This means that p [x, y] representative of the image projected on the imaging device 29 can be calculated in accordance with H (x, y, z) representative of the transfer function with i (x, y) representative of the object parameter.

As described in the above, the image formed on the imaging device 29 includes the in-focus image portion and the out-of-focus image portion. The image improving filter section 33 is operative to compensate the out-of-focus image portion by way of the image improving operation according to the present invention. The image improving operation carried out by the image improving filter section 33 will be described in detail hereinlater.

The image improving filter section 33 has stored therein arrays of coefficients corresponding to an inverse function represented by 1/H (x, y, z), which is in inverse relation to the transfer function H (x, y, z) representative of the transfer characteristic of the multifocal lens 210. The fact that the image improving filter section 33 has stored therein arrays of coefficients corresponding to the inverse function represented by 1/H (x, y, z) leads to the fact that the transfer characteristic of the cascade connection of the multifocal lens 210 and the image improving filter section 33 is equal to one, viz., 1. This means that the output image represented by o (x, y) becomes equal to the object represented by i ((x, y), thereby leading to the fact that the out-of-focus image portion has been eliminated.

As clearly seen from FIG. 4, the image improving filter section 33 includes image improving filter coefficient calculating means 330 for calculating the arrays of coefficients to be stored in the image improving filter section 33. The arrays of coefficients to be stored in the image improving filter section 33 correspond to a transfer function of the image improving filter section 33, represented by W (x, y, z), viz., the inverse function represented by 1/H (x, y, z), which is in inverse relation to the transfer function H (x, y, z) representative of the transfer characteristic of the multifocal lens 210. In the present embodiment, it is assumed that the object is disposed at a reference distance c from the multifocal lens 210, and the image improving filter section 33 has in advance stored therein the arrays of coefficients corresponding to PSF h (0, 0, c) representative of the PSF of the multifocal lens 210 with respect to the object disposed at the reference distance c. This means that PSF h (0, 0, c) has been in advance measured and calculated. The image improving filter coefficient calculating means 330 is firstly operative to calculate H (0, 0, c) representative of the transfer function based on PSF h (0, 0, c). The image improving filter coefficient calculating means 330 is then operative to calculate the arrays of coefficients w (x, y) by performing, for example, inverse Fourier transformation, inverse FFT (fast Fourier transformation), or the like on the inverse function 1/H (x, y, z), which is in inverse relation to the transfer function transfer function H (x, y, z). The arrays of coefficients w (x, y) thus calculated serve as compensating coefficients, viz., filter coefficients of the image improving filter section 33. As will be seen from the foregoing description, the image improving filter coefficient calculating means 330 is operative to calculate the filter coefficients w (x, y) based on the reference distance c between the object and the optical system constituted by the multifocal lens 210, viz., in advance measured PSF h (0, 0, c) representative of the PSF of the multifocal lens 210 with respect to the object disposed at the reference distance c.

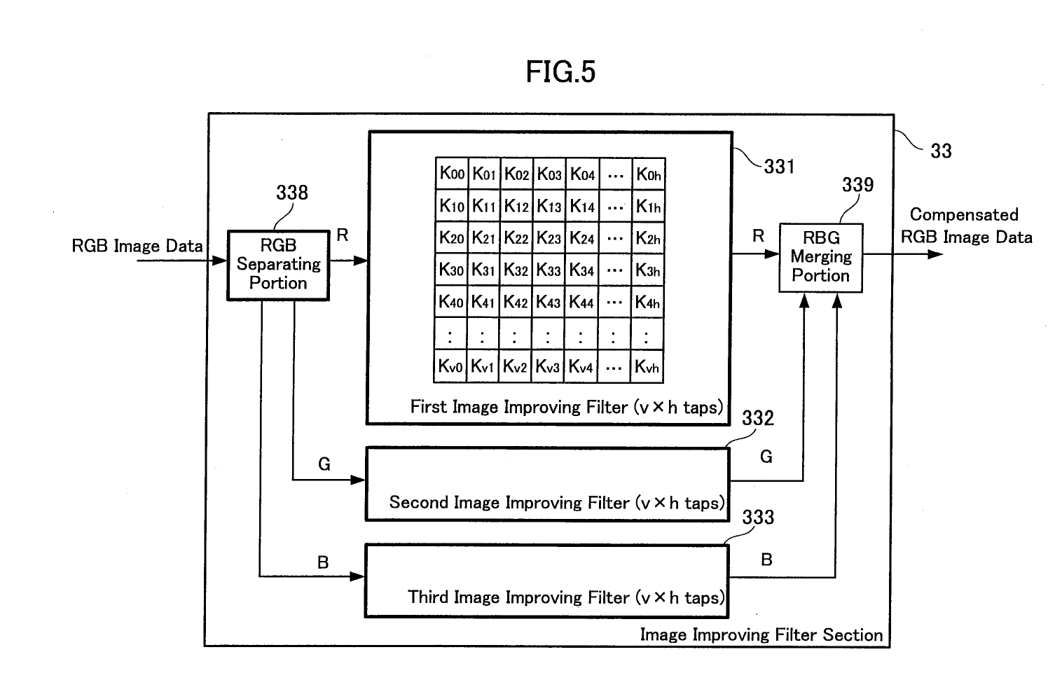

The construction of the image improving filter section 33 section forming part of the imaging apparatus will be described in detail with reference to FIG. 5.

The image improving filter section 33 is operative to input the raw image signal from the imaging device 29. The raw image signal is in the form of a digitalized RGB image data made up of red, green and blue data components indicative of three primary colors. The image improving filter section 33 includes a RGB separating portion 338 for separating the raw image signal into red, green and blue data components, a first image improving filter 331 for filtering the red data components to produce compensated red data, a second image improving filter 332 for filtering the green data components to produce compensated green data, and a third image improving filter 333 for filtering the blue data components to produce compensated blue data. Each of the first, second and third image improving filters 331, 332, and 333 is constituted by a two dimensional digital filter.

As clearly seen from FIG. 5, the first image improving filter 331 has a plurality of taps collectively forming a matrix, viz., arrays of the number v of taps in a vertical direction X and the number h of taps in a horizontal direction Y perpendicular to the vertical direction X. Each of the arrays of the taps forming part of the first image improving filter 331 has stored therein each of the arrays of coefficients K00, K01, K02, . . . , K10, K11, . . . and Kvh calculated by the image improving filter coefficient calculating means 330. The first image improving filter 331 thus constructed is operative to input the red data components to be aligned in the form of the matrix in vertical and horizontal directions, and add up the arrays of red data components respectively multiplied by the arrays of coefficients correspondent in positions of the matrix to produce compensated red data.

The construction of each of the second and third image improving filters 332 and 333 is similar to that of the first image improving filter 331 and thus will not be described to avoid tedious repetition. Similar to the first image improving filter 331, the second image improving filter 332 thus constructed is operative to add up the arrays of green data components respectively multiplied by the arrays of coefficients to produce compensated green data, and the third image improving filter 333 thus constructed is operative to add up the arrays of blue data components respectively multiplied by the arrays of coefficients to produce compensated blue data. The image improving filter section 33 further includes an RGB merging portion 339 for merging the compensated red, green and blue data to produce compensated image data.

While there has been described in the above about the fact that the image improving filter section 33 is constituted by functional blocks including digital filters and the like, according to the present invention, the image improving filter section 33 may be constituted by any other means executable to carry out an image improving method necessary to implement the above mentioned processes. The image improving method includes an inputting step of inputting the raw image signal made up of red, green and blue data components from the AD converting section 32, a computing step of adding up the red, green and blue data components respectively multiplied by the arrays of coefficients calculated by the image improving filter coefficient calculating means 330 to produce image data, and an image outputting step of outputting the image data produced in the computing step. In addition, the same effect can still be obtained when the image improving filter section 33 is at least in part constituted by, for example, a computer program stored in, for example, a memory or the like, executable by, for example, a processor to implement the above mentioned processes. Further, the signal processing section 35 and the control section 39 forming part of the image processing unit 30 may be constituted by any other means executable to carry out the above mentioned processes. In addition, the same effect can still be obtained when the signal processing section 35 and the control section 39 forming part of the image processing unit 30 are constituted by, for example, a computer program stored in, for example, a memory or the like, executable by, for example, a processor to implement the above mentioned processes.

From the foregoing description, it will be understood that the present embodiment of the imaging apparatus according to the present invention can take a sharp image of an object with ease and high precision regardless of whether the object is disposed at a reference distance or at a distance shorter than the reference distance, resulting from the fact that the present embodiment of the imaging apparatus comprises a multifocal lens 210 constituted by a far lens portion 22 and a near lens portion 23 for taking an image of the object to have the image converted into an image signal, and an image improving filter section 33 for compensating and improving the image signal with arrays of filter coefficients corresponding to an inverse function of a point spread function of the multifocal lens 210 with respect to the object disposed at the reference distance. In the present embodiment, the multifocal lens 210 is constituted by the far lens portion 22 and the near lens portion 23 both in the form of a semi-circular shape and neighboring to each other along a line extending through the center of the multifocal lens 210 to respectively form an upper half portion and a lower half portion of the multifocal lens 210 viewed from a direction extending along the optical axis 10 of the multifocal lens 210. This leads to the fact that the image formed by the multifocal lens 210 in the case that the point-like light source is disposed at a far distance is substantially similar in shape to the image formed by the multifocal lens 210 in the case that the point-like light source is disposed at a near distance as clearly seen from FIGS. 3B and 3D. This means that the PSF representative of the image formed by the multifocal lens 210 with respect to the near distance is approximately the same as the PSF representative of the image formed by the multifocal lens 210 with respect to the far distance. This results in the fact that the image improving filter section 33 is required to have store therein arrays of filter coefficients only for a single reference distance between the object and the optical system, thereby eliminating the needs of storing arrays of filter coefficients for each of possible distances, for example, a far distance, a near distance, or the like, at which the object may be disposed with respect to the optical system. The present embodiment of the imaging apparatus according to the present invention thus constructed as previously mentioned can take a sharp image of an object using the multifocal lens with ease and high precision regardless of whether the object is disposed therefrom at a reference distance or at a distance shorter than the reference distance while eliminating the need of focusing mechanism as well as preventing the processes from increasing in number.

While it has been described in the above the far lens portion 22 forms an upper half portion of the multifocal lens 210 and the near lens portion 23 forms a lower lens portion of the multifocal lens 210, in the imaging apparatus according to the present invention, the far lens portion 22 and the near lens portion 23 may form any parts of the multifocal lens 210 as long as the far lens portion 22 and the near lens portion 23 are both in the form of a semi-circular shape and neighboring to each other along a line extending through the center of the multifocal lens 210 to collectively complete the multifocal lens 210 in the form of a circular shape viewed from a direction extending along the optical axis 10 of the multifocal lens 210. It is needless to mention that, for example, the far lens portion 22 forms a lower half portion of the multifocal lens 210 and the near lens portion 23 forms an upper lens portion of the multifocal lens 210.

Though it has been described in the present embodiment that the multifocal lens 210 is constituted by a first lens portion 22 forming a first semi-circular portion of the multifocal lens 210 and a second lens portion 23 forming a second semi-circular portion of the multifocal lens 210 neighboring to the first lens portion 22 to complete the multifocal lens 210 in cooperation with the first semi-circular portion 22 viewed from a direction extending along the optical axis 10 of the multifocal lens 210, the multifocal lens 210 may be constituted by a first lens portion in the form of, for example, a semi-elliptical or semi-polygonal shape and a second lens portion in the form of a semi-elliptical or semi-polygonal shape and neighboring to the first lens portion along a line extending through the center of the multifocal lens 210 to complete the multifocal lens 210 in the form of an elliptical or polygonal shape in cooperation with the first lens portion viewed from a direction extending along the optical axis 10 of the multifocal lens 210.

### Second Preferred Embodiment

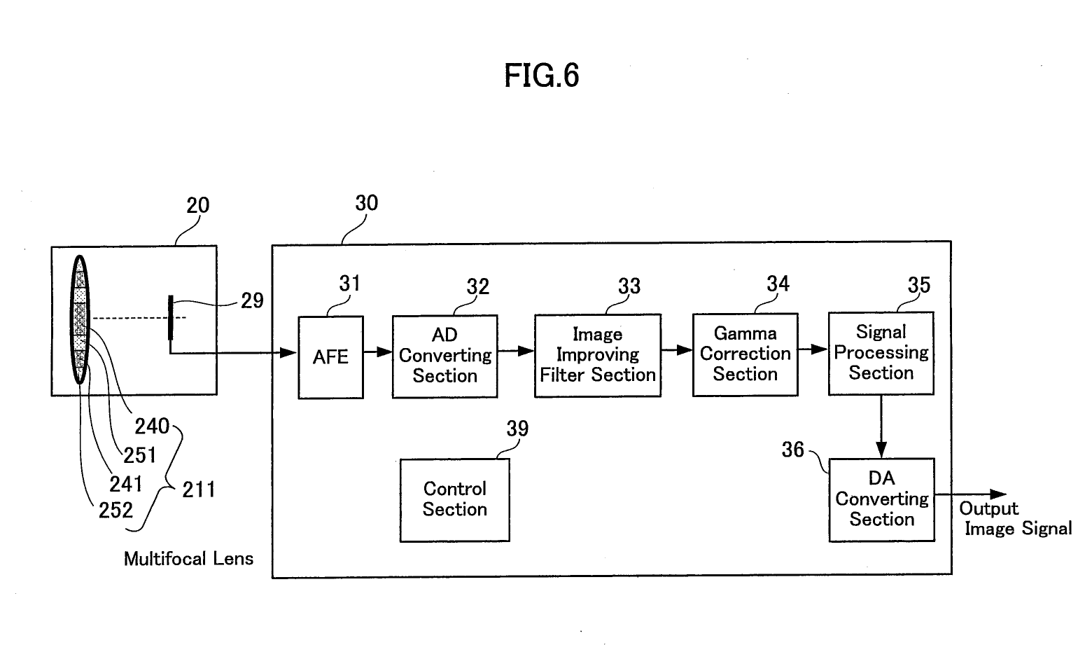

FIG. 6 is a block diagram showing a second preferred embodiment of the imaging apparatus according to the present invention. The constituent elements of the second embodiment of the imaging apparatus the same as those of the first embodiment of the imaging apparatus will not be described in detail but bear the same reference numerals as those of the first embodiment of the imaging apparatus.

As will be clearly seen from FIG. 6, the present embodiment of the imaging apparatus according to the present invention comprises an optical system constituted by an imaging unit 20 for taking an image of an object to have the image converted into an electric signal as a raw image signal, and an image processing unit 30 for carrying out an image processing operation on the raw image signal inputted from the imaging unit 20 to produce an image signal as an output image signal.

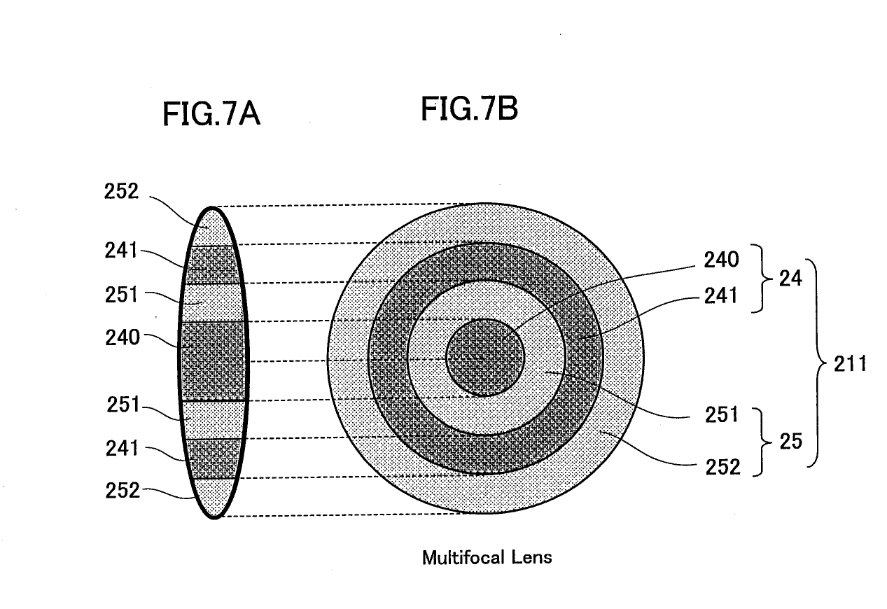

In the present embodiment, the imaging unit 20 includes a multifocal lens 211 different from the multifocal lens 211 forming part of the first embodiment of the imaging apparatus. FIG. 7 is a block diagram showing an example of a multifocal lens 211 forming part of the present embodiment of the imaging apparatus. FIG. 7A is a side view of the multifocal lens 211 viewed from a direction perpendicular to an optical axis 10 of the multifocal lens 211. FIG. 7B is a front view of the multifocal lens 211 viewed from a direction extending along the optical axis of the multifocal lens 211. As clearly seen from FIG. 7, the multifocal lens 211 is a multifocal optical system constituted by a circular lens portion and a plurality of annular lens portions disposed in concentric relationship with the multifocal lens 211 viewed from a direction extending along the optical axis of the multifocal lens 211. This means that the multifocal lens 211 is constituted by a circular first lens portion 240 and an annular first lens portion 241 each having a first focal length, and annular second lens portions 251 and 252 each having a second focal length shorter than the first focal length, wherein the circular first lens portion 240, the annular second lens portion 251, the annular first lens portion 241, and the annular second lens portion 252 are integrally formed with one another, and collectively form a front plane of the multifocal lens 211 viewed from a direction extending along the optical axis of the multifocal lens 211 as shown in FIG. 7B. The annular second lens portion 251 extends radially outwardly of the circular first lens portion 240, the annular first lens portion 241 extends radially outwardly of the annular second lens portion 251, and the annular second lens portion 252 extends radially outwardly of the annular first lens portion 241. In this example of the multifocal lens 211 shown in FIG. 7, the circular first lens portion 240 and the annular first lens portion 241 collectively constitute a far lens portion 24 and the annular second lens portions 251 and 252 collectively constitute a near lens portion 25, and the first focal length is longer than the second focal length.

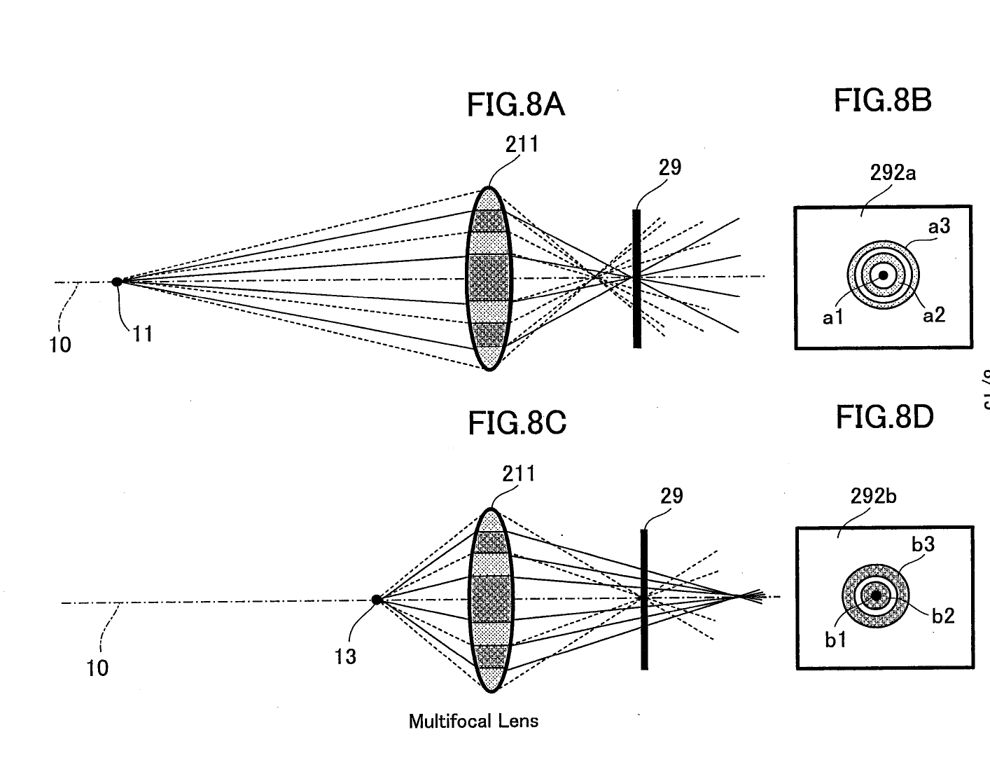

FIG. 8 shows how images are focused by the multifocal lens 211 and formed on the imaging device 29. FIG. 8A shows a view explaining how an image is formed on the imaging device 29 in the case that the point-like light source is disposed at the focal point 11 of the far lens portion 24. FIG. 8B is a front view of a projected image 292a formed on the imaging device 29 viewed from a direction extending along the optical axis 10 of the multifocal lens 211. As will be clearly seen from FIG. 8B, the image 292a formed on the imaging device 29 is a composite of an image portion a1 in sharp focus formed by the far lens portion 24 collectively constituted by the circular first lens portion 240 and the annular first lens portion 241, an image portion a2 out of focus formed by the annular second lens portion 251, and an image portion a3 out of focus formed by annular second lens portion 252 wherein the in-focus image portion a1 is in the form of a point-like shape, the out-of-focus image portion a2 is in the form of an annular shape and extending radially outwardly of and spaced apart from the in-focus image portion a1, and the out-of-focus image portion a3 is in the form of an annular shape and extending radially outwardly of and spaced apart from the out-of-focus image portion a2.

Likewise, FIG. 8C shows a view explaining how an image is formed on the imaging device 29 in the case that the point-like light source is disposed at the focal point 13 of the near lens portion 25. FIG. 8D is a front view of a projected image 292b formed on the imaging device 29 viewed from a direction extending along the optical axis 10 of the multifocal lens 211. As will be clearly seen from FIG. 8D, the image 292b formed on the imaging device 29 is a composite of an image portion b1 in sharp focus formed by the near lens portion 25 constituted by the annular second lens portion 251 and 252, an image portion b2 out of focus formed by the circular first lens portion 240, and an image portion b3 out of focus formed by the annular first lens portion 241 wherein the in-focus image portion b1 is in the form of a point-like shape, the out-of-focus image portion b2 is in the form of a circular shape and extending radially outwardly of the in-focus image portion b1, and the out-of-focus image portion b3 is in the form of an annular shape and extending radially outwardly of and spaced apart from the out-of-focus image portion b2.

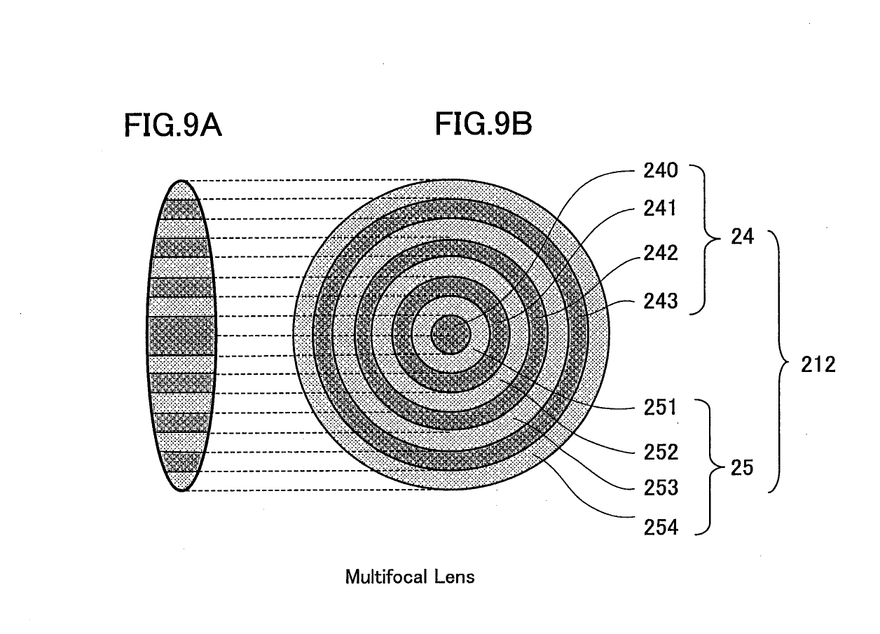

FIG. 9 is a block diagram showing another example of a multifocal lens 212 forming part of the present embodiment of the imaging apparatus. FIG. 9A is a side view of the multifocal lens 212 viewed from a direction perpendicular to an optical axis 10 of the multifocal lens 212. FIG. 9B is a front view of the multifocal lens 212 viewed from a direction extending along the optical axis of the multifocal lens 212. As clearly seen from FIG. 9, the multifocal lens 212 is a multifocal optical system constituted by a circular lens portion and a plurality of annular lens portions disposed in concentric relationship with the multifocal lens 212 viewed from a direction extending along the optical axis of the multifocal lens 212. This means that the multifocal lens 212 is constituted by a circular first lens portion 240 and annular first lens portions 241, 242, and 243 each having a first focal length, and annular second lens portions 251, 252, 253, and 254 each having a second focal length shorter than the first focal length, wherein the circular first lens portion 240, the annular second lens portion 251, the annular first lens portion 241, the annular second lens portion 252, the annular first lens portion 242, the annular second lens portion 253, the annular first lens portion 243, the annular second lens portion 254 are integrally formed with one another, and collectively form a front plane of the multifocal lens 212 as shown in FIG. 9B. The annular second lens portion 251 extends radially outwardly of the circular first lens portion 240, the annular first lens portion 241 extends radially outwardly of the annular second lens portion 251, the annular second lens portion 252 extends radially outwardly of the annular first lens portion 241, the annular first lens portion 242 extends radially outwardly of the annular second lens portion 252, the annular second lens portion 253 extends radially outwardly of the annular first lens portion 242, the annular first lens portion 243 extends radially outwardly of the annular second lens portion 253, and the annular second lens portion 254 extends radially outwardly of the annular first lens portion 243. In this example of the multifocal lens 212 shown in FIG. 9, the circular first lens portion 240, the annular first lens portions 241, 242, and 243 collectively constitute a far lens portion 24 and the annular second lens portions 251, 252, 253, and 254 collectively constitute a near lens portion 25, and the first focal length is longer than the second focal length.

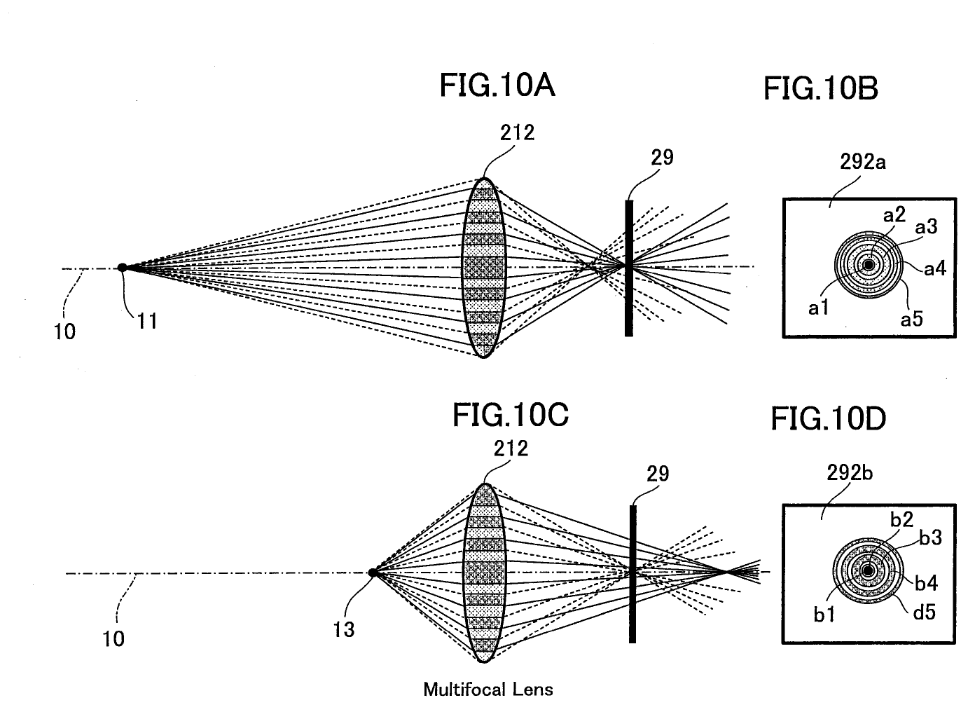

FIG. 10 is a block diagram explaining how an image of an object is formed on the imaging device 29 forming part of the present embodiment of the imaging apparatus having the multifocal lens 212 shown in FIG. 9. FIG. 10A shows how an image of the object is formed on the imaging device 29 in the case that the object is disposed at the focal point 11 of the far lens portion 24. FIG. 10B is a front view of the image 292a formed on the imaging device 29 shown in FIG. 10A viewed from a direction extending along the optical axis 10 of the multifocal lens 212. As will be clearly seen from FIG. 10B, the image 292a formed on the imaging device 29 is a composite of an image portion a1 in sharp focus formed by the far lens portion 24 collectively constituted by the circular first lens portion 240 and the annular first lens portions 241, 242, and 243, an image portion a2 out of focus formed by the annular second lens portion 251, an image portion a3 out of focus formed by annular second lens portion 252, an image portion a4 out of focus formed by annular second lens portion 253, and an image portion a5 out of focus formed by annular second lens portion 254, wherein the in-focus image portion a1 is in the form of a point-like shape, the out-of-focus image portion a2 is in the form of an annular shape and extending radially outwardly of and spaced apart from the in-focus image portion a1, the out-of-focus image portion a3 is in the form of an annular shape and extending radially outwardly of and spaced apart from the out-of-focus image portion a2, the out-of-focus image portion a4 is in the form of an annular shape and extending radially outwardly of and spaced apart from the out-of-focus image portion a3, and the out-of-focus image portion a5 is in the form of an annular shape and extending radially outwardly of and spaced apart from the out-of-focus image portion a4.

Likewise, FIG. 10C shows a view explaining how an image is formed on the imaging device 29 in the case that the point-like light source is disposed at the focal point 13 of the near lens portion 25. FIG. 10D is a front view of a projected image 292b formed on the imaging device 29 viewed from a direction extending along the optical axis 10 of the multifocal lens 212. As will be clearly seen from FIG. 10D, the image 292b formed on the imaging device 29 is a composite of an image portion b1 in sharp focus formed by the near lens portion 25 constituted by the annular second lens portions 251, 252, 253, and 254, an image portion b2 out of focus formed by the circular first lens portion 240, an image portion b3 out of focus formed by the annular first lens portion 241, an image portion b4 out of focus formed by the annular first lens portion 242, and an image portion b5 out of focus formed by the annular first lens portion 243 wherein the in-focus image portion b1 is in the form of a point-like shape, the out-of-focus image portion b2 is in the form of an annular shape and extending radially outwardly of the in-focus image portion b1, the out-of-focus image portion b3 is in the form of an annular shape and extending radially outwardly of and spaced apart from the out-of-focus image portion b2, the out-of-focus image portion b4 is in the form of an annular shape and extending radially outwardly of and spaced apart from the out-of-focus image portion b3, and the out-of-focus image portion b5 is in the form of an annular shape and extending radially outwardly of and spaced apart from the out-of-focus image portion b4.

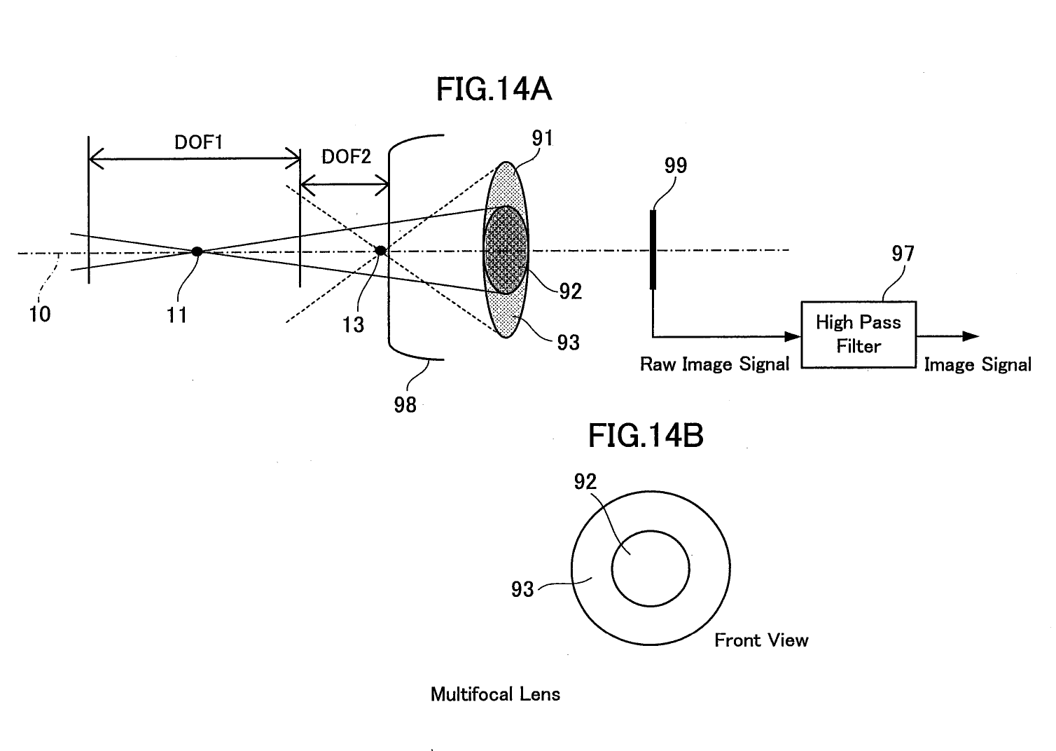

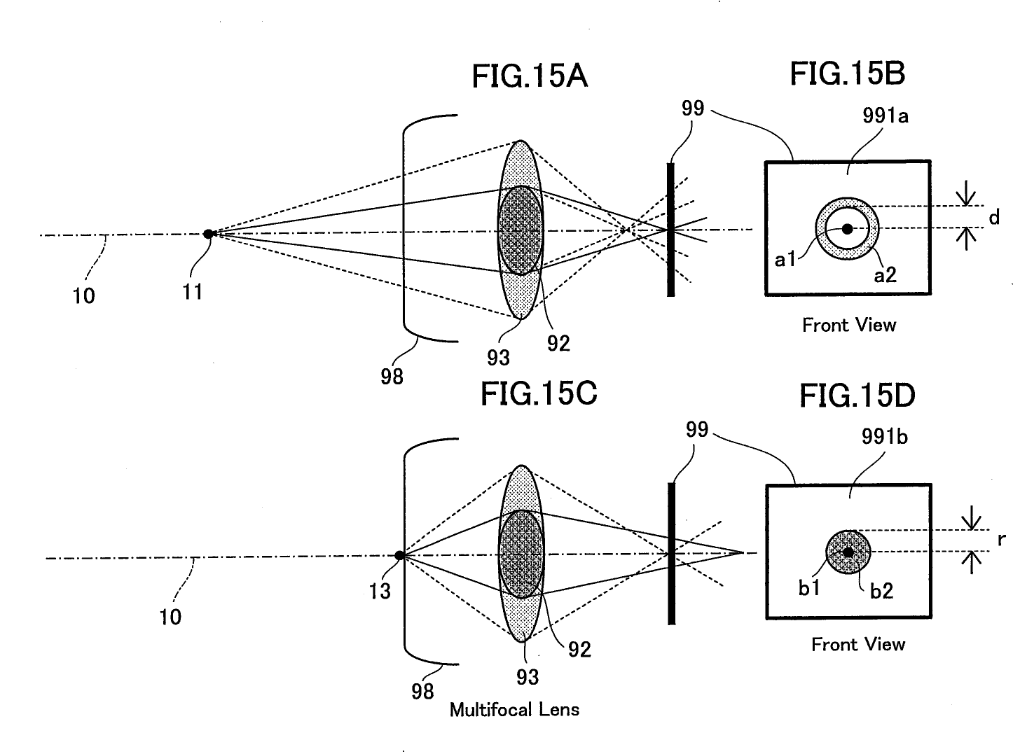

In the conventional bar code reading apparatus as described in the above with reference to FIGS. 14B and 14D, the out-of-focus image formed on the imaging device 99 selectively takes the form of a circular shape and an annular shape, and thus variable in the case that the object is disposed along the optical axis 10 of the bifocal lens 91 constituted by the far lens portion 92 and the near lens portion 93 wherein the far lens portion 92 is in the form of a circular shape and the near lens portion 93 is in the form of an annular shape and extending radially outwardly of a peripheral edge of the far lens portion 92 viewed from a direction extending along the optical axis 10 of the multifocal lens 91. In the imaging apparatus according to the present invention, on the other hand, the out-of-focus image formed on the imaging device 29 takes the form of a plurality of annular shapes disposed in concentric relationship with one another, as clearly seen from FIGS. 8B and 8D, in the case that the object is disposed along the optical axis 10 of the multifocal lens 211 constituted by a circular first lens portion 240 and a plurality of annular lens portions 241, 251, and 252 respectively in concentric relationship with the circular first lens portion 240, wherein each of the circular first lens portion 240 and the annular first lens portion 241 has a first focal length, and each of the annular second lens portions 251 and 252 has a second focal length shorter than the first focal length, as shown in FIG. 7. As clearly seen from FIGS. 10B, 10D, 8B, and 8D, the number of annular image portions collectively forming the out-of-focus image focused by the multifocal lens 212 on the imaging device 29 is larger than the number of annular image portions collectively forming the out-of-focus image focused by the multifocal lens 211 on the imaging device 29. On the basis of the comparison between the out-of-focus images focused by the multifocal lens 211 and the multifocal lens 212, it is concluded that the number of annular image portions collectively forming the out-of-focus image focused by the multifocal lens rises with the increase in the number of annular near lens portions and annular far lens portions disposed respectively in concentric relationship with and collectively forming part of the multifocal lens, wherein the annular far lens portions each having a far focal length are disposed respectively in alternately neighboring relationship with the annular near lens portions each having a near focal length shorter the far focal length. This leads to the fact that the out-of-focus image focused by the multifocal lens on the imaging device 29 collectively formed by the annular image portions increasingly takes the form of a circular shape with the increase in the number of the annular image portions collectively forming the out-of-focus image focused by the multifocal lens on the imaging device 29. This means that the out-of-focus image focused and projected by the multifocal lens on the imaging device 29 in the case that the object is disposed at the focal point 11 of the far lens portion is substantially similar in shape with the out-of-focus image focused and projected by the multifocal lens on the imaging device 29 in the case that the object is disposed at the focal point 13 of the near lens regardless of whether the multifocal lens is constituted by the multifocal lens 211 or the multifocal lens 212.

It is therefore concluded that in the present embodiment the PSF with respect to the far lens portion 24 forming part of the multifocal lens and the PSF with respect to the near lens portion 25 forming part of the multifocal lens become increasingly similar with each other with the increase in the number of annular near lens portions and annular far lens portions respectively in concentric relationship with and collectively forming part of the multifocal lens. While it has been described in the present embodiment of the imaging apparatus and image improving method about the fact that the multifocal lens is constituted by the multifocal lens 211 or 212 by way of example, the multifocal lens may be constituted by any other multifocal lens as long as the multifocal lens is constituted by a plurality of lens portions respectively having a focal length, and each of the PSFs with respect to the lens portions can be approximated by one PSF with respect to one representative lens portion, hereinlater simply referred to as “representative PSF”, selected from among a plurality of the PSFs with respect to the lens portions. In the present embodiment, the image improving filter section 33 forming part of the image processing unit 30 thus constructed has stored therein arrays of coefficients corresponding to the representative PSF.

From the foregoing description, it will be appreciated that the present embodiment of the imaging apparatus thus constructed can take a sharp image of an object with ease and high precision regardless of whether the object is disposed at a reference distance or at a distance shorter than the reference distance, resulting from the fact that the present embodiment of the imaging apparatus comprises an image improving filter section 33 having stored therein, as filter coefficients, arrays of coefficients corresponding to an inverse function in inverse relation to the transfer function of the representative PSF of the multifocal lens 211 or 212 with respect to the object disposed at a reference distance c from the multifocal lens 211 or 212 and operative to carry out an image improving operation on the raw image signal by compensating the out-of-focus image portion of the raw image signal in accordance with the filter coefficients. Further, the present embodiment of the imaging apparatus thus constructed can obtain the image substantially in the form of a circular shape on the imaging device 29 by the multifocal lens 211 or 212 regardless of whether or not the point-like light source is disposed at the far distance or the near distance as shown in, for example, FIGS. 10B and 10D, resulting from the fact that the multifocal lens 211 or 212 is constituted by a circular first lens portion 240, a plurality of annular far lens portions 24, and a plurality of annular near lens portions 25 respectively in concentric relationship with the circular first lens portion 240, wherein the annular far lens portions 24 each having a far focal length are disposed respectively in alternately neighboring relationship with the annular near lens portions 25 each having a near focal length shorter the far focal length. The fact that in the present embodiment of the imaging apparatus thus constructed the PSFs with respect to the far lens portions 24 and the PSF with respect to the near lens portion 25 forming part of the multifocal lens 211 or 212 are substantially the same leads to the fact that the PSF of the multifocal lens remains substantially unchanged regardless of whether the object is disposed at a near distance or a far distance. This results in the fact that the present embodiment of the imaging apparatus thus constructed is required to have the image improving filter section 33, for example, store therein filter coefficient corresponding to the single representative PSF alone, thereby eliminating the need of calculating and preparing in advance filter coefficients corresponding to the PSF with respect to every possible position of the object for the image improving filter section 33. This leads to the fact that the present embodiment of the imaging apparatus according to the present invention thus constructed can take a sharp image of an object using the multifocal lens with ease and high precision regardless of whether the object is disposed therefrom at a reference distance or at a distance shorter than the reference distance while eliminating the need of focusing mechanism as well as preventing the processes from increasing in number.

While it has been described in the present embodiment about the fact that the multifocal lens is constituted by the multifocal lens 211 or 212 shown in FIGS. 7 and 9 by way of example, the multifocal lens may be constituted by any other multifocal lens as long as the multifocal lens is constituted by a circular lens portion, a plurality of annular first lens portions and a plurality of annular second lens portions respectively in concentric relationship with the circular lens portion, wherein the annular first lens portions each having a first focal length are disposed respectively in alternately neighboring relationship with the annular second lens portions each having a second focal length different from the first focal length, and the repetition of the annular first lens portion and the annular second lens portion in neighboring relationship with the annular first lens portion is not limited in the number. The image improving filter section 33 can be improved in precision with the increase in the number of the repetitions of the annular first lens portion and the annular second lens portion in neighboring relationship with the annular first lens portion, resulting from the fact that both of the PSFs with respect to the first and second lens portions forming part of the multifocal lens increasingly become approximated to the representative PSF.

Though it has been described in the above about the fact that the circular first lens portion 240 forming part of the multifocal lens is a far lens portion, according to the present invention, it is needless to mention that the multifocal lens may be replaced by a multifocal lens constituted by a circular near lens portion in place of the circular first lens portion 240, one or more annular far lens portions and one or more annular near lens portions disposed respectively concentric relationship with the circular near lens portion, wherein the circular near lens portion is neighboring relationship with one of the annular far lens portions, and the annular near lens portions are respectively in alternately neighboring relationship with the annular far lens portions.

While it has been described in the above about the fact that each of the annular far lens portions and each of the annular near lens portions are the same in width viewed from a direction extending along the optical axis 10 of the multifocal lens, it is needless to mention that the present invention is not limited to the exemplified construction. According to the present invention, the multifocal lens may be constituted by a circular first lens portion, a plurality of annular first lens portions, and a plurality of annular second lens portions respectively in concentric relationship with the first lens portion, wherein the annular first lens portions each having a first focal length are disposed respectively in alternately neighboring relationship with the annular second lens portions each having a second focal length different from the first focal length, and the total area of the circular first lens portion and the annular first lens portions is substantially equal to the total area of the annular second lens portions. In the multifocal lens thus constructed, the total surface of the first lens portions and total surface of the second lens portions are substantially equal to each other in the light utilization ratio, thereby making it possible for the imaging apparatus according to the present invention to obtain an image of an object with evenly distributed contrast regardless of weather the object is disposed at a far distance or a near distance.

Though it has been described in the above that the multifocal lens is constituted by a bifocal lens having a far lens portion and a near lens portion, according to the present invention, it is needless to mention that the present invention is not limited to the bifocal lens. The multifocal lens may be constituted by more than two lens portions different from one another in focal length. This means that the multifocal lens may be constituted by, for example, a circular lens portion, and an annular first lens portion, an annular second lens portion, . . . , and an annular N-th lens portion respectively in concentric relationship with the circular lens portion, wherein the annular first lens portion, the annular second lens portion, . . . , and the annular N-th lens portion are different from one another in focal length. N is an integer equal to or greater than two. The multifocal lens portion may be further constituted by, a 2nd annular first lens portion, 2nd annular second lens portion, . . . , and 2nd annular N-th lens portion respectively in concentric relationship with the circular lens portion and radially extending outwardly of the N-th lens portion, . . . , and an i-th annular first lens portion, an i-th annular second lens portion, . . . , and an i-th annular N-th lens portion respectively in concentric relationship with the circular lens portion and radially extending outwardly of the (i-1)-th N-th lens portion. Here, the first annular j-th lens portion, the second annular j-th lens portion, . . . , and i-th annular j-th lens portion are equal in focal length to one another, wherein i is an integer equal to or greater than two, and j is an integer ranging between one to N. The fact that the multifocal lens thus constructed as previously mentioned comprises a plurality of lens portions respectively different from one another in focal length leads to the fact that the multifocal lens thus constructed can have a plurality of DOFs of the lens portions forming part of the multifocal lens, thereby, as a whole, deepening the DOF of the multifocal lens.

Though it has been described in the present embodiment that the multifocal lens 211 or 212 is constituted by a circular lens portion and a plurality of annular lens portions disposed in concentric relationship with the circular lens portion as shown in FIG. 7 or 9, according to the present invention, the multifocal lens may be constituted by any other lens portions as long as the lens portions are disposed in concentric relationship with one another viewed from a direction extending along the optical axis 10 of the multifocal lens 211 or 212. The multifocal lens may be constituted by, for example, an elliptical or polygonal lens portion, and a plurality of elliptical or polygonal annular lens portions respectively disposed in concentric relationship with the elliptical or polygonal lens portion to collectively complete the multifocal lens in the form of an elliptical or polygonal shape in cooperation with elliptical or polygonal lens portion viewed from a direction extending along the optical axis 10 of the multifocal lens 211 or 212.

### Third Preferred Embodiment

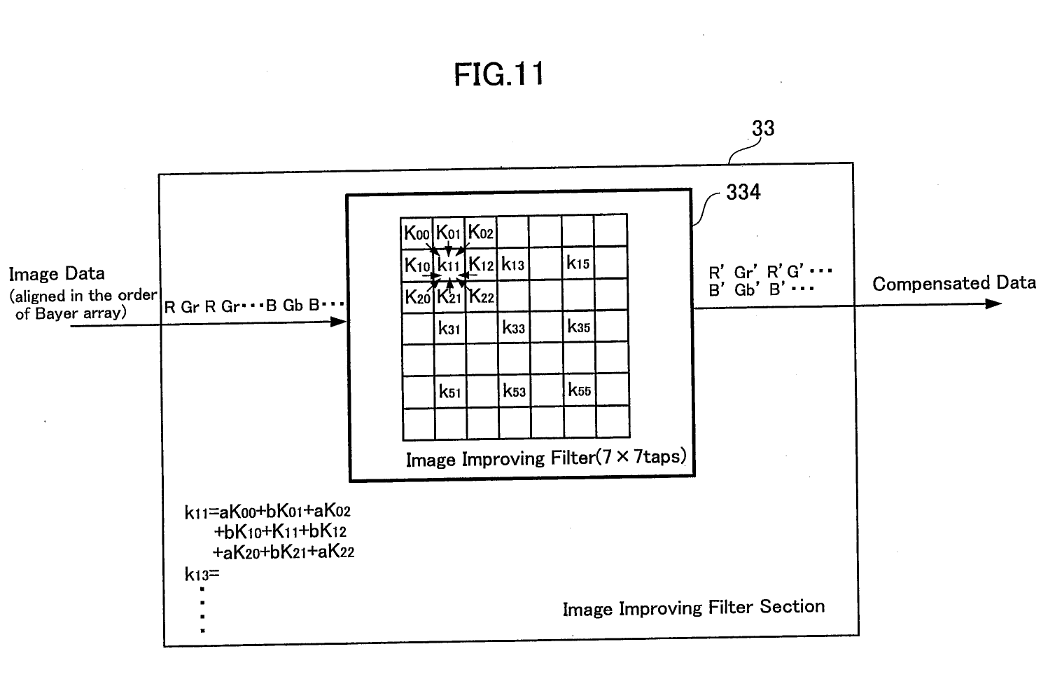

FIG. 11 is a block diagram showing a construction of an image improving filter section 33 forming part of a third preferred embodiment of the imaging apparatus according to the present invention. The image improving filter section 33 is operative to compensate the out-of-focus image portion, for example, focused by the multifocal lens 211 or 212 on the imaging device 29 by way of the image improving operation according to the present invention. The image improving operation carried out by the present embodiment of the image improving filter section 33 will be described in detail hereinlater.

The present embodiment of the image improving filter section 33 shown in FIG. 11 is similar to the first embodiment of the image improving filter section 33 shown in FIG. 5 except for the fact that the present embodiment of the image improving filter section 33 includes, for example, an image improving filter 334 as shown in FIG. 11. The image improving filter 334 includes a plurality of taps collectively forming a matrix, viz., arrays of, for example, seven taps in a vertical direction X and seven taps in a horizontal direction Y perpendicular to the vertical direction X. Each of the taps forming part of the image improving filter 334 corresponds to each of primary colors of the image projected and formed on the imaging device 29 in a position of the matrix.

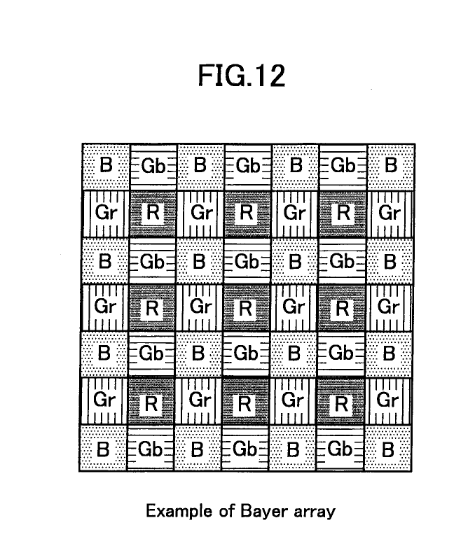

It is hereinlater assumed that the imaging device 29 is constituted by solid-state image sensing devices respectively corresponding to image elements and aligned in the form of a matrix in a vertical and horizontal directions in the order of Bayer array, and operative to output a raw image signal in the form of a digitalized image data made up of a plurality of primary color data components, for example, an R data component, a Gr data component, a B data component, and a Gb data component to be aligned in the form of the matrix in a vertical and horizontal directions in the order of the Bayer array. FIG. 12 is a block diagram showing an example of Bayer array of solid-state imaging devices forming part of the third preferred embodiment of the imaging apparatus according to the present invention. The imaging device 29 is constituted by a plurality of primary color sensing devices respectively corresponding to image elements and aligned checker-wise in the form of a matrix as clearly seen from FIG. 12, and operative to output image data elements, viz., an R data component, a Gr data component, a B data component, and a Gb data component in a time-series manner to be aligned in the form of the matrix in the order of the Bayer array respectively corresponding to the primary color sensing devices in positions of the matrix. The present embodiment of the image improving filter section 33 is characterized in that the present embodiment of the image improving filter section 33 comprises only one image improving filter 334 constituted by an acyclic type digital filter having stored therein, as filter coefficients, arrays of coefficients corresponding to a predetermined compensation function, in place of the first, second and third image improving filters 331, 332, and 333 forming part of the second embodiment of the image improving filter section 33. This means that the present embodiment of the image improving filter section 33 alone is operative to add up arrays of image data elements forming part of the image data respectively multiplied by the arrays of the coefficients correspondent in positions of the matrix and stored in the storage section using a single image improving filter.

While the first embodiment of the image improving filter section 33 shown in FIG. 5 is operative to add up the arrays of red data components respectively multiplied by the arrays of coefficients to produce compensated red data, add up the arrays of green data components respectively multiplied by the arrays of coefficients to produce compensated green data, add up the arrays of blue data components respectively multiplied by the arrays of coefficients to produce compensated blue data in parallel, the present embodiment of the image improving filter section 33 shown in FIG. 11 is operative to add up R data components respectively multiplied by the arrays of coefficients to produce compensated R′ data, the arrays of Gr data components respectively multiplied by the arrays of coefficients to produce compensated Gr′ data, add up the arrays of B data components respectively multiplied by the arrays of coefficients to produce compensated B′ data, and add up the arrays of Gb data components respectively multiplied by the arrays of coefficients to produce compensated Gb′ data in a time-series manner. Accordingly, the present embodiment of the image improving filter section 33 can process data components of only one color at a predetermined time interval. This leads to the fact that the present embodiment of the image improving filter section 33, on the other hand, cannot process the data components of the other colors while processing data components of one color. This means that the present embodiment of the image improving filter section 33 cannot utilize, for example, Gr, B, or Gb data components, while the present embodiment of the image improving filter section 33 is processing, for example, R data components.

Among the arrays of the taps forming part of the image improving filter 334 forming part of the present embodiment of the image improving filter section 33, only each of taps disposed in positions of receiving a particular color data component has stored therein a filter coefficient at a predetermined time interval as best shown in FIG. 11 because of the fact that, particularly, in the case of the Bayer array, a plurality of primary color data components are processed at the respective taps positioned checker-wise as shown in FIG. 12. At a time interval while processing, for example, R data components, only the taps disposed in positions of receiving the R data components have stored therein respective filter coefficients k₁₁, k₁₃, k₁₅, k₃₁, k₃₃, k₃₅, k₅₁, k₅₃, and k₅₅. This means that the image improving filter 334 has stored therein only the arrays of coefficients, k₁₁, k₁₃, k₁₅, k₃₁, k₃₃, k₃₅, k₅₁, k₅₃, and k₅₅ and the other coefficients, for example, K00, K01, K02, K10, K12, K20, K21, K22, . . . are thinned out at the time interval. Here, the array of coefficients corresponding to the positions of the R data components and stored in the image improving filter 334, i.e., k₁₁, k₁₃, k₁₅, k₃₁, k₃₃, k₃₅, k₅₁, k₅₃, and k₅₅ will be hereinlater referred to as “effective coefficients”, and the thinned out coefficients, i.e., K00, K01, K02, K10, K12, K20, K21, K22, . . . will be hereinlater referred to as “ineffective coefficients”.

Further, in the present embodiment, the image improving filter coefficient calculating means 330 is operative to calculate effective filter coefficients based on the result of adding up the candidate effective filter coefficients and ineffective filter coefficients respectively multiplied by predetermined weighted values for the purpose of preventing the precision of the effective filter coefficient from degrading due to ineffective filter coefficients thinned out. This means that the image improving filter coefficient calculating means 330 is operative to calculate, for example, an effective filter coefficient k₁₁, through the following step. Firstly, the image improving filter coefficient calculating means 330 is operated to calculate a candidate effective filter coefficient K11 corresponding to the R data component in the matrix and ineffective filter coefficients K00, K01, K02, K10, K12, K20, K21, K22, in the vicinity of the candidate effective filter coefficient K11 in the matrix in accordance with a predetermined compensation function, and add up the candidate effective filter coefficient K11 and the ineffective filter coefficients K00, K01, K02, K10, K12, K20, K21, K22, respectively multiplied by predetermined weighted values to calculate the effective filter coefficient k₁₁ as clearly seen from FIG. 11. The image improving filter coefficient calculating means 330 is operative to calculate the other effective filter coefficient k₁₃, k₁₅, k₃₁, k₃₃, k₃₅, k₅₁, k₅₃, k₅₅ in the same manner as described in the above.

From the foregoing description, it will be appreciated that the present embodiment of the imaging apparatus and the image improving method according to the present invention thus constructed as previously mentioned can take a sharp image of an object with ease and high precision regardless of whether the object is disposed therefrom at a reference distance or at a distance shorter than the reference distance while eliminating the need of focusing mechanism as well as preventing the processes from increasing in number and reducing the digital filter in scale, resulting from the fact that the present embodiment of the image improving filter section 33 makes it possible for a single image improving filter 334 to add up primary color data components respectively multiplied by the effective filter coefficients.

While there has been described in the above about the fact that the image improving filter section 33 is constituted by functional blocks including digital filters and the like, according to the present invention, it is needless to mention that the present embodiment of the image improving filter section 33 may be constituted by any other means executable to carry out an image improving method necessary to implement the above mentioned processes. In addition, the same effect can still be obtained when the image improving filter section 33 is at least in part constituted by, for example, a computer program stored in, for example, a memory or the like, executable by, for example, a processor to implement the above mentioned processes. Further, the signal processing section 35 and the control section 39 forming part of the image processing unit 30 may be constituted by any other means executable to carry out the above mentioned processes. In addition, the same effect can still be obtained when the signal processing section 35 and the control section 39 forming part of the image processing unit 30 are at least in part constituted by, for example, a computer program stored in, for example, a memory or the like, executable by, for example, a processor to implement the above mentioned processes.

While it has been described in the present embodiment about the fact that the image improving filter section 33 is operative to carry out the image improving operation on the digitalized image data made up of a plurality of primary color data components, viz., an R data component, a Gr data component, a B data component, and a Gb data component supplied in the order of the Bayer array, according to the present invention, the image improving filter section 33 may be applicable to any other digitalized image data as long as the image data is made up of a plurality of color data components supplied in such a manner that each of the color data components is regularly repeated. The image improving filter section 33 may be applicable to, for example, digitalized image data made up of a plurality of complementary color data components, outputted from the imaging device constituted by a plurality of complementary color sensing devices aligned checker-wise, in such a manner that each of the complementary color data components is regularly repeated.

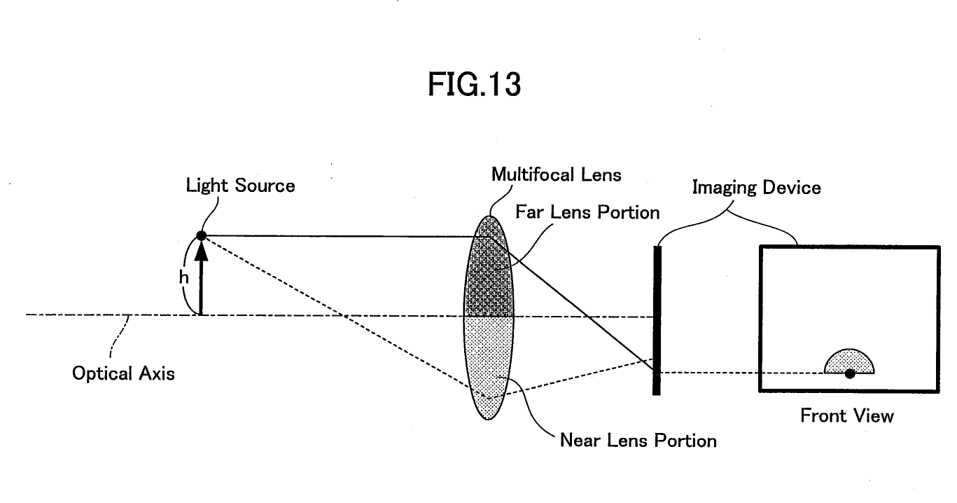

While it has been described in the first, second and third embodiments about the fact that the image improving filter section 33 is operative to carry out the image improving operation with filter coefficients determined based on the representative PSF, which is calculated with respect to one representative lens portion forming part of the multifocal lens, the representative PSF may be calculated by any other ways as long as the representative PSF can approximate the PSF of each of the lens portions forming part of the multifocal lens. The representative PSF may be calculated through the steps of, for example, calculating all of the PSFs of the lens portions forming part of the multifocal lens with respect to respective focal points to produce the PSFs, multiplying all of the PSFs by respective ratios, adding up all of the PSFs thus multiplied by respective ratios to produce a total of the composite PSFs, and averaging the total of the composite PSFs to produce a representative PSF. Further, in the case that the object is disposed on a focal plane, for example, apart from the optical axis of the multifocal lens at a predetermined distance h as shown in FIG. 13, the representative PSF may be calculated through the steps of, for example, calculating all of the PSFs of the lens portions forming part of the multifocal lens with respect to respective focal points on respective focal planes disposed apart from the optical axis of the multifocal lens at the predetermined distance h to produce the PSFs, multiplying all of the PSFs by respective ratios, adding up all of the PSFs thus multiplied by respective ratios to produce a total of the composite PSFs, and averaging the total of the composite PSFs to produce a representative PSF. Here, each of the ratio may be determined based on, for example, an angle of the light beam incident from the point-like light source on each of the respective lens portions.

Further, in the first, second and third embodiments, stray light may be generated from each of adjoining places where the neighboring lens portions are fixedly connected with each other. Accordingly, it is needless to mention that appropriate light shielding processes may be carried out on each of the adjoining places in order to further enhance the precision of the imaging apparatus.

### INDUSTRIAL APPLICABILITY OF THE PRESENT INVENTION

From the foregoing description, it will be appreciated that the imaging apparatus according to the present invention is available for an imaging apparatus such as, for example, a camera, a video camera as well as an information mobile terminal having an imaging function such as, for example, a mobile cellular phone, and others, resulting from the fact that the imaging apparatus according to the present invention can take a sharp image of an object with ease and high precision regardless of whether the object is disposed therefrom at a reference distance or at a distance shorter than the reference distance while eliminating the need of focusing mechanism as well as preventing the processes from increasing in number.

What is claimed is:

1. An imaging apparatus, comprising:
a multifocal lens having a plurality of lens portions different from one another in focal length;
an imaging device for converting an image formed thereon by said multifocal lens into an electric signal to be outputted therethrough as an image signal;
a computing unit for carrying out a weighted computing process on said image signal from said imaging device in accordance with a predetermined compensation function to output a compensated image signal as an output image signal, and in which
said compensation function is an inverse function obtained based on a point spread function with respect to an object disposed at a predetermined distance from an optical system constituted by said multifocal lens.

2. An imaging apparatus as set forth in claim 1, in which
said multifocal lens has a representative lens portion, and
said point spread function with respect to said object disposed at said predetermined distance from said optical system is a point spread function of said multifocal lens with respect to said object disposed at a focal point of said representative lens portion.

3. An imaging apparatus as set forth in claim 2, in which
said point spread function of said multifocal lens is a point spread function with respect to said object disposed at said focal point of said representative lens portion on an optical axis of said multifocal lens.

4. An imaging apparatus as set forth in claim 2, in which
said point spread function of said multifocal lens is a point spread function with respect to said object disposed at said focal point of said representative lens portion on a focal plane spaced apart at a predetermined distance from an optical axis of said multifocal lens.

5. An imaging apparatus as set forth in claim 1, in which
said point spread function with respect to said object disposed at said predetermined distance from said optical system is a point spread function obtained based on the result of multiplying a point spread function of each of said lens portions forming part of said multifocal lens with respect to its focal point by a predetermined ratio, and adding up said point spread functions of all of said lens portions thus multiplied by said predetermined ratios.

6. An imaging apparatus as set forth in claim 5, in which
said point spread function with respect to said object disposed at said predetermined distance from said optical system is a point spread function obtained based on the result of multiplying a point spread function of each of said lens portions forming part of said multifocal lens with respect to its focal point on an optical axis of said multifocal lens by a predetermined ratio, and adding up said point spread functions of all of said lens portions thus multiplied by said predetermined ratios.

7. An imaging apparatus as set forth in claim 5, in which
said point spread function with respect to said object disposed at said predetermined distance from said optical system is a point spread function obtained based on the result of multiplying a point spread function of each of said lens portions forming part of said multifocal lens with respect to its focal point on a focal plane spaced apart at a predetermined distance from an optical axis of said multifocal lens by a predetermined ratio, and adding up said point spread functions of all of said lens portions thus multiplied by said predetermined ratios.

8. An imaging apparatus as set forth in claim 1, in which
said multifocal lens is constituted by a first lens portion having a first focal length and a second lens portion having a second focal length different from said first focal length,
said first lens portion and said second lens portion are integrally formed with each other and collectively form a plane of said multifocal lens in the form of a shape selected from among a circular shape, an elliptical shape, and a polygonal shape viewed from a direction extending along an optical axis of said multifocal lens, and
said first lens portion and said second lens portion are neighboring to each other along a straight line extending through a center of said multifocal lens.

9. An imaging apparatus as set forth in claim 1, in which
said multifocal lens is constituted by a first lens portion having a first focal length and a second lens portion having a second focal length different from said first focal length,
said first lens portion and said second lens portion are integrally formed with each other, and
said first lens portion and said second lens portion are alternately neighboring to each other in concentric relationship with one of said first lens portion and said second lens portion in the form of a shape selected from among a circular shape, an elliptical shape, and a polygonal shape to collectively form a plane of said multifocal lens viewed from a direction extending along an optical axis of said multifocal lens.

10. An imaging apparatus as set forth in claim 1, in which
said multifocal lens is constituted by a group of the number N of lens portions including a first lens portion to a N-th lens portion respectively having focal lengths different from one another, N being an integer equal to or greater than two,
the number N of said lens portions including said first lens portion to said N-th lens portion are integrally formed with one another, and
the number N of said lens portions including said first lens portion to said N-th lens portion are disposed respectively in alternately neighboring relationship with one another in concentric relationship with said first lens portion in the form of a shape selected from among a circular shape, an elliptical shape, and a polygonal shape to collectively form a plane of said multifocal lens viewed from a direction extending along an optical axis of said multifocal lens.

11. An imaging apparatus as set forth in claim 10, in which
said multifocal lens portion is constituted by the number M of groups including said first group to M-th group of lens portions each group having the number N of lens portions including a i-th first lens portion to an i-th N-th lens portion respectively equal in focal length to said first lens portion to said N-th lens portion, M being an integer equal to or greater than one, and i is an integer equal to or less than M,
said i-th first lens portion to said i-th N-th lens portion are disposed respectively in alternately neighboring relationship with one another in concentric relationship with said first lens portion and radially extending outwardly of (i-1)-th N-th lens portion, and
the number M×N of said lens portions including said first lens portion to said M-th N-th lens portion are integrally formed with one another and collectively form a plane of said multifocal lens viewed from a direction extending along an optical axis of said multifocal lens.

12. An imaging apparatus as set forth in claim 1, in which
said multifocal lens has one ore more adjoining places where neighboring lens portions are fixedly connected with each other, and a light shielding process is made on each of said adjoining places in order to reduce stray light generated therefrom.

13. An imaging apparatus as set forth in any one of claims 8 and 9, in which
a total area of said first lens portion is substantially equal to a total area of said second lens portion viewed from a direction extending along an optical axis of said multifocal lens.

14. An imaging apparatus as set forth in claim 10, in which
the number N of lens portions are substantially equal in a total area to one another viewed from a direction extending along an optical axis of said multifocal lens.

15. An imaging apparatus as set forth in claim 1, in which
said computing unit includes a digital filter section having stored therein arrays of coefficients obtained in accordance with said predetermined compensation function,
said digital filter section is operative to input, as said image signal, digitalized image data converted from said image signal outputted from said imaging device and carrying out a computing process on said image signal based on the result of multiplying said image data by said coefficients.

16. An imaging apparatus as set forth in claim 15, in which
said image signal outputted from said imaging device is made up of a plurality of data components to be aligned in the form of a matrix in vertical and horizontal directions,
said digital filter section is constituted by a two-dimensional digital filter having stored therein a plurality of coefficients calculated in accordance with said predetermined compensation function,
said coefficients are to be aligned in the form of said matrix in vertical and horizontal directions and respectively corresponding to said data components in positions of said matrix, and
said digital filter is operative to carry out said weighted computing process on said image signal based on the result of multiplying each of said data components by one of said coefficients corresponding to each of said data components in said position of said matrix, and adding up all of said data components thus multiplied by said coefficients.

17. An imaging apparatus as set forth in claim 16, in which
said imaging device is constituted by solid-state image sensing devices respectively corresponding to image elements aligned in the form of said matrix in vertical and horizontal directions, and respectively corresponding to said data components in positions of said matrix.

18. An imaging apparatus as set forth in claim 17, in which
said image signal outputted from said imaging device includes red, green and blue data components respectively indicative of three primary colors, and
said digital filter section is operative to carry out a weighted computing process on each of said red, green and blue data components.

19. An imaging apparatus as set forth in claim 17, in which
said solid-state image sensing devices respectively correspond to a plurality of image elements each indicative of a primary color and are aligned checker-wise to output, as an image signal, a plurality of data components each indicative of said primary color in the order that said solid-state image sensing devices are aligned.

20. An imaging apparatus as set forth in claim 19, in which
said computing unit is operative to input said data components respectively outputted from said solid-state image sensing devices, and
said digital filter section is operative to carry out said weighted computing process on each of said data components with said plurality of coefficients.

21. An imaging apparatus as set forth in claim 20, in which
said coefficients include an effective coefficient corresponding to an image element in said matrix,
said effective coefficient is calculated based on the result of multiplying a coefficient corresponding to said image element in said matrix and a plurality of neighboring coefficients placed in the vicinity of said coefficient in said matrix by respective predetermined weighted values, and adding up said coefficient and said neighboring coefficients respectively thus multiplied.

22. An imaging apparatus as set forth in claim 19, in which
said solid-state image sensing devices are aligned in the order of Bayer array to output R, Gr, B, and GB data components respectively indicative of primary colors in the order of Bayer array.

23. An image improving method, comprising
a preparing step of preparing a multifocal lens having a plurality of lens portions different from one another in focal length; an imaging device for converting an image formed thereon by said multifocal lens into an electric signal to be outputted therethrough as an image signal;
an inputting step of inputting said image signal,
a converting step of converting said image signal into digitalized image data,
a computing step of carrying out a weighted computing process on said image data in accordance with a compensation function to obtain compensated image data, said compensation function being an inverse function of a point spread function with respect to an object disposed at a predetermined distance from an optical system constituted by said multifocal lens, and
an outputting step of outputting said compensated image data as output image data.

24. An image improving method as set forth in claim 23, in which
said multifocal lens has a representative lens portion, and
said point spread function with respect to said object disposed at said predetermined distance from said optical system is a point spread function of said multifocal lens with respect to said object disposed at a focal point of said representative lens portion.

25. An imaging improving method as set forth in claim 24, in which
said point spread function of said multifocal lens is a point spread function with respect to said object disposed at said focal point of said representative lens portion on an optical axis of said multifocal lens.

26. An imaging improving method as set forth in claim 24, in which
said point spread function of said multifocal lens is a point spread function with respect to said object disposed at said focal point of said representative lens portion on a focal plane spaced apart at a predetermined distance from an optical axis of said multifocal lens.

27. An image improving method as set forth in claim 23, in which
said point spread function with respect to said object disposed at said predetermined distance from said optical system is a point spread function obtained based on the result of multiplying a point spread function of each of said lens portions forming part of said multifocal lens with respect to its focal point by a predetermined ratio, and adding up said point spread functions of all of said lens portions thus multiplied by said predetermined ratios.

28. An image improving method as set forth in claim 27, in which
said point spread function with respect to said object disposed at said predetermined distance from said optical system is a point spread function obtained based on the result of multiplying a point spread function of each of said lens portions forming part of said multifocal lens with respect to its focal point on an optical axis of said multifocal lens by a predetermined ratio, and adding up said point spread functions of all of said lens portions thus multiplied by said predetermined ratios.

29. An image improving method as set forth in claim 27, in which
said point spread function with respect to said object disposed at said predetermined distance from said optical system is a point spread function obtained based on the result of multiplying a point spread function of each of said lens portions forming part of said multifocal lens with respect to its focal point on a focal plane spaced apart at a predetermined distance from an optical axis of said multifocal lens by a predetermined ratio, and adding up said point spread functions of all of said lens portions thus multiplied by said predetermined ratios.

30. An image improving method as set forth in claim 23, in which
said computing step has a step of carrying out a convolution computation of said image data to an array of coefficients obtained in accordance with said predetermined compensation function.

31. An image improving method as set forth in claim 30, in which
said image data is made up of a plurality of data components to be aligned in the form of a matrix in vertical and horizontal directions,
said coefficients are to be aligned in the form of said matrix in vertical and horizontal directions and respectively corresponding to said data components in positions of said matrix,
said computing step has a step of carrying out a convolution computation of said data components to said coefficients respectively correspondent in said positions of said matrix.

32. An image improving method as set forth in claim 31, in which
said imaging device is constituted by a plurality of solid-state image sensing devices respectively corresponding to a plurality of image elements each indicative of a primary color and are aligned checker-wise in the form of said matrix in vertical and horizontal directions to output, as an image signal, a plurality of data components each indicative of said primary color in the order that said solid-state image sensing devices are aligned, and
said computing step has a step of carrying out a convolution computation of said data components to said coefficients respectively correspondent in said positions of said matrix.

33. An image improving method as set forth in claim 32, in which
said coefficients include an effective coefficient corresponding to an image element in said matrix,
said effective coefficient is calculated based on the result of multiplying a coefficient corresponding to said image element in said matrix and a plurality of neighboring coefficients placed in the vicinity of said coefficient in said matrix by respective predetermined weighted values, and adding up said coefficient and said neighboring coefficients respectively thus multiplied.

34. An image improving method as set forth in claim 32, in which
said solid-state image sensing devices are aligned in the order of Bayer array to output R, Gr, B, and GB data components respectively indicative of primary colors in the order of Bayer array.
said computing step has a step of carrying out a convolution computation of said R, Gr, B, and GB data components to said coefficients respectively correspondent in said positions of said matrix.
